(19) United States
(12) Patent Application Publication
(10) Pub. No.: US 2011/0255470 A1
(43) Pub. Date: Oct. 20, 2011

(54) DATA PROCESSING DEVICE, SYSTEM AND METHOD FOR DATA PROCESSING, RECORDING MEDIUM WITH PROGRAM RECORDED THEREIN, DATA TRANSFER DEVICE, SYSTEM AND METHOD FOR DATA TRANSFER, AND RECORDING MEDIUM WITH PROGRAM RECORDED THEREIN

(75) Inventor: Yukihiro Fukami, Kanagawa (JP)

(73) Assignee: PIONEER CORPORATION, KAWASAKI-SHI (JP)

(21) Appl. No.: 13/132,138

(22) PCT Filed: Dec. 1, 2008
(86) PCT No.: PCT/JP2008/071806

§ 371 Date: Jun. 22, 2011

(51) Int. Cl. H04W 40/00

(52) U.S. Cl. 370/328

(57) ABSTRACT

When the first radio unit receives CEC frame data from the PDP and recognizes that a second BDP (destination) is connected to a second radio unit and the CEC frame data does not include a Give command, the first radio unit substitutes for the second BDP to give an ACK response for reporting the reception of the CEC frame data by the second BDP, and sends the CEC frame data to the second BDP. When the first radio unit recognizes that the second BDP is connected and the CEC frame data contains a Give command, the first radio unit sends the CEC frame data to the second BDP without giving an ACK response; when the first radio unit recognizes that the second BDP has received the CEC frame data, the first radio unit gives an ACK response to the same Give command that is re-sent by the PDP and prompts the PDP to start a timer at that timing.

### TECHNICAL FIELD

The present invention relates to a data processing device, a data processing system, a data processing method and program for data processing, and a recording medium storing the program; and a data transfer device, a method and a program for data transfer, and a recording medium storing the program.

### BACKGROUND ART

There has been typically known an arrangement for executing processing based on a CEC (Consumer Electronics Control) frame format complying with the HDMI (High-Definition Multimedia Interface) standard (see, e.g., Patent Literature 1).

Patent Literature 1 discloses a radio communication system including a source unit and a sink unit.
Patent Literature 1: JP-A-2008-109711

### DISCLOSURE OF THE INVENTION

### Problems to be Solved by the Invention

However, when a radio unit is provided in a wired CEC network, since a CEC line to be ideally shared cannot be shared, further problems arise. One of the problems is a deterioration of a response to a command of a CEC frame data. Specifically, the Patent Literature 1 only discloses a command that requires a return response. When a command requiring a return response is sent by wireless, the command may experience a timeout on account of transmission delay. For instance, when a command that requires a return response (e.g. CEC Give command [referred to as Give command hereinafter]) is transmitted by a CEC device and a return response (CEC Report command [referred to as Report command hereinafter]) is not obtained within a second after the CEC device receives an ACK signal of the Give command, the CEC device may abort the process. Such process abort of the CEC command on account of timeout should be preferably avoided. Secondly, since a CEC line is usually shared in a CEC communication between the devices, a rule has been set up in the HDMI standard for prohibiting simultaneous start of the communication. However, when a CEC line cannot be shared, more than two CEC line networks exist, where the respective devices can start communication in each of the networks according to the communication rule, so that communication traffic and communication contents may differ. Such situation should be preferably avoided.

An object of the invention is to provide a data processing device, a data processing system, a data processing method and program for data processing and a recording medium storing the program; and a data transfer device, a method and a program for data transfer, and a recording medium storing the program that allow an appropriate transmission process from a first device to a second device.

### Means for Solving the Problems

A data processing device according to the invention receives CEC frame data containing second device information specifying a second device designated as a destination from a first device as processing data, and sends the processing data to a second device adapted to perform a process based on the processing data, the data processing device including: a processing-side memory that stores the second device information specifying the second device; a data receiver that receives the processing data from the first device; an ACK response substitution executor that gives an ACK response for reporting reception of the processing data by the second device specified by the second device information in place of the second device when the data receiver receives the processing data; and a data transmitter that transmits the processing data received by the data receiver to the second device specified by the second device information, where the ACK response substitution executor gives the ACK response in place of the second device when the second device information contained in the processing data is stored in the processing-side memory and the processing data does not contain a command that requires a return response, the ACK response substitution executor does not give the ACK response in place of the second device when the second device information contained in the processing data is stored in the processing-side memory and the processing data contains a command that requires a return response, and the ACK response substitution executor gives the ACK response in place of the second device when the ACK response substitution executor recognizes that the second device receives the processing data.

The data processing device according to another aspect of the invention receives CEC frame data containing second device information specifying a second device designated as a destination from a first device as processing data, and sends the processing data to a second device adapted to perform a process based on the processing data, the data processing device including: a processing-side memory that stores the second device information specifying the second device; a data receiver that receives the processing data from the first device; a return response information memory that stores return response information relating to a return response for the processing data before the processing data is transmitted from the first device; and a return response substitution executor that transmits the return response information in the return response information memory in place of the second device when the second device information contained in the processing data is stored in the processing-side memory and the processing data requests a return response of the return response information stored in the return response information memory.

A data processing device according to still another aspect of the invention receives CEC frame data containing second device information specifying a second device designated as a destination from a first device as processing data, and sends the processing data to a second device adapted to perform a process based on the processing data, the data processing device including: a data receiver that receives the processing data from the first device; a data transmitter that transmits the processing data received by the data receiver to the second device specified by the second device information; and a first command transmitter that transmits predetermined command information to all of the first devices when the processing data is transmitted by the data transmitter.

A data transfer device according to further aspect of the invention receives CEC frame data containing second device information specifying a second device designated as a destination from a first device as processing data, and transfers the processing data to a second device adapted to perform a process based on the processing data, the data transfer device including: a data transferer that transfers the processing data to the second device specified by the second device information and transfers the return response to the first device when receiving a return response from the second device to the processing data; and a second command transmitter that transmits predetermined command information to all of the second devices when recognizing that the return response is received by the data transferer.

A data processing system according to still further aspect of the invention includes: a data transfer device including a data transferer that receives CEC frame data containing second device information specifying a second device designated as a destination from a first device as processing data and is connected to a second device adapted to perform a process based on the processing data to transfer the processing data to the second device specified by the second device information; and the data processing device according to the above aspects being connected to the first device and the data transfer device to send the processing data from the first device to the second device via the data transfer device.

A data processing system according to the invention includes: a data processing device that receives CEC frame data containing second device information specifying a second device designated as a destination from a first device as processing data, and sends the processing data to a second device adapted to perform a process based on the processing data; and the above data transfer device that transmits the processing data transmitted by the data processor to the second device specified by the second device information.

A data processing system according to still further aspect of the invention includes: a data transfer device including a data transferer that receives CEC frame data containing second device information specifying a second device designated as a destination from a first device as processing data and is connected to a second device adapted to perform a process based on the processing data to transfer the processing data to the second device specified by the second device information; and a data processing device connected to the first device and the data transfer device to send the processing data from the first device to the second device via the data transfer device, where the data processing device comprises a data divider that divides the processing data into a plurality of divided data and sends the processing data to the data transfer device for each of the plurality of divided data, and the data transferer receives the divided data and reconstructs the divided data into the processing data in an order for the divided data to be received.

A data processing system according to still further aspect of the invention includes: a data transfer device including a data transferer that receives CEC frame data containing second device information specifying a second device designated as a destination from a first device as processing data and is connected to a second device adapted to perform a process based on the processing data to transfer the processing data to the second device specified by the second device information; and a data processing device connected to the first device and the data transfer device to send the processing data from the first device to the second device via the data transfer device, where the data processing device comprises: a data receiver that receives the processing data from the first device; a data transmitter that transmits the processing data received by the data receiver to the second device specified by the second device information; and a first command transmitter that transmits predetermined command information to all of the first devices when the processing data is transmitted by the data transmitter, and the data transfer device comprises a second command transmitter that transmits predetermined command information to all of the second devices when recognizing that the processing data is received by the data transferer.

A data processing method according to still further aspect of the invention is performed by a computer, the method including: receiving CEC frame data containing second device information specifying a second device designated as a destination from a first device as processing data; sending the processing data to a second device adapted to perform a process based on the processing data; providing a processing-side memory that stores the second device information specifying the second device; receiving the processing data from the first device; judging whether or not the second device information contained in the processing data is stored in the processing-side memory and whether or not the processing data contains a command that requires a return response; giving an ACK response reporting that the processing data is received by the second device specified by the second device information in place of the second device only when it is judged in the judging that the second device information contained in the processing data is stored in the processing-side memory and the processing data does not include the command that requires the return response; and transmitting the processing data received in the receiving to the second device specified by the second device information.

A data processing method according to still further aspect of the invention is performed by a computer, the method including: receiving CEC frame data containing second device information specifying a second device designated as a destination from a first device as processing data; sending the processing data to a second device adapted to perform a process based on the processing data; storing the second device information for specifying the second device in a processing-side memory; storing return response information related to a return response to the processing data in a return response information memory; receiving the processing data from the first device; judging whether or not the second device information contained in the processing data is stored in the processing-side memory and whether or not the processing data requires the return response of the return response information stored in the return response information memory; and transmitting the return response information in the return response information memory to the first device in place of the second device when it is judged in the judging that the second device information contained in the processing data is stored in the processing-side memory and the processing data requires the return response of the return response information stored in the return response information memory.

A data processing method according to still further aspect of the invention is performed by a computer, the method including: receiving CEC frame data containing second device information specifying a second device designated as a destination from a first device as processing data; sending the processing data to a second device adapted to perform a process based on the processing data; receiving the processing data from the first device; data-transmitting the processing data received in the receiving to the second device specified by the second device information; and stimulated by an actuation of the data-transmitting, transmitting predetermined command information to a CEC network to which the first device is connected.

A data transfer method according to still further aspect of the invention is performed by a computer, the method including: receiving CEC frame data containing second device information specifying a second device designated as a destination from a first device as processing data; transferring the processing data to a second device adapted to perform a process based on the processing data; transferring the processing data to the second device specified by the second device information and, when receiving a return response to the processing data from the second device, transferring the return response to the first device; and transmitting predetermined command information to a CEC network to which the second device is connected when recognizing that the return response is received in the transferring.

A data transfer method according to still further aspect of the invention uses a data processing system including: a data transfer device including a data transferer that receives CEC frame data containing second device information specifying a second device designated as a destination from a first device as processing data and is connected to a second device adapted to perform a process based on the processing data to transfer the processing data to the second device specified by the second device information; and a data processing device connected to the first device and the data transfer device to send the processing data from the first device to the second device via the data transfer device, the method transferring the processing data to the second device and comprising: dividing the processing data into a first divided data and a second divided data succeeding the first divided data; receiving the first divided data by the data processing device in a first time; transmitting the first divided data to the data transfer device in a third time shorter than the first time; receiving the second divided data by the data processing device in a second time transmitting the second divided data to the data transfer device in a fourth time shorter than the second time; after receiving the first divided data by the data transfer device from the data processing device, transmitting the first divided data to the second device in the first time; and after receiving the second divided data by the data transfer device from the data processing device, transmitting the second divided data to the second device in the second time subsequently to the first divided data.

A data processing program according to still further aspect of the invention allows a computer to perform the data processing method according to the above aspects of the invention.

A data transfer program according to still further aspect of the invention allows a computer to perform the data transfer method according to the above aspects of the invention.

A data processing program according to still further aspect of the invention allows a computer to function as the data processing device according to the above aspects of the invention.

A data transfer program according to still further aspect of the invention allows a computer to function as the data transfer device according to the above aspect of the invention.

A recording medium according to still further aspect of the invention stores the data processing program according to the above aspect in a manner readable by a computer.

A recording medium according to still further aspect of the invention stores the data transfer program according to the above aspect in a manner readable by a computer.

### BRIEF DESCRIPTION OF DRAWINGS

FIG. 1 schematically shows an arrangement of a logical address assignment information according to first to fourth exemplary embodiments of the invention.

FIG. 2 schematically shows CEC frame data according to the first to fourth exemplary embodiments of the invention.

FIG. 3 schematically shows a general arrangement of an HDMI system according to the first to fourth exemplary embodiments.

FIG. 4 is a block diagram showing a general arrangement of a first radio unit according to the first exemplary embodiment.

FIG. 5 schematically shows a shared device list according to the first to fourth exemplary embodiments.

FIG. 6 schematically shows node information according to the first to fourth exemplary embodiments.

FIG. 7 is a block diagram showing a general arrangement of a second radio unit according to the first and third exemplary embodiments.

FIG. 8 schematically shows a device connection status and a logical address assignment status before the first radio unit and the second radio unit are connected according to the third exemplary embodiment.

FIG. 9 schematically shows a device connection status and a logical address assignment status after the first radio unit and the second radio unit are connected according to the first to fourth exemplary embodiments.

FIG. 10 is a timing chart showing the operation performed when the first radio unit and the second radio unit are connected according to the first to fourth exemplary embodiments.

FIG. 11 is a timing chart showing the operation performed when the first radio unit and the second radio unit are connected according to the first to fourth exemplary embodiments.

FIG. 12 is a timing chart showing the operation performed when the first radio unit and the second radio unit are connected according to the first to fourth exemplary embodiments.

FIG. 13 schematically shows a PDP recognition list according to the first to fourth exemplary embodiments.

FIG. 14 is a timing chart showing the operation performed when CEC Give command is sent and received according to the first exemplary embodiment.

FIG. 15 is a timing chart showing the operation performed when CEC Give command is sent and received according to a comparative example of the first exemplary embodiment.

FIG. 16 is a block diagram showing a general arrangement of a first radio unit according to the second exemplary embodiment.

FIG. 17 is a block diagram showing a general arrangement of a second radio unit according to the second exemplary embodiment.

FIG. 18 is a timing chart showing the operation performed when CEC Give command is sent and received according to the second exemplary embodiment.

FIG. 19 is a block diagram showing a general arrangement of a first radio unit according to the third exemplary embodiment.

FIG. 20 is a timing chart showing the operation of the first and second radio units performed when CEC frame data is sent and received according to the third exemplary embodiment.

FIG. 21 is a timing chart showing an operation of an HDMI system performed when CEC Give command is sent and received in an example employing the above method in the first exemplary embodiment.

FIG. 22 is a timing chart showing the operation of the first and second radio units performed when CEC frame data is sent and received according to a comparative example in the third exemplary embodiment.

FIG. 23 is a block diagram showing a general arrangement of a first radio unit according to the fourth exemplary embodiment.

FIG. 24 is a block diagram showing a general arrangement of a second radio unit according to the fourth exemplary embodiment.

FIG. 25 is a timing chart showing the operation performed when CEC Give command is sent and received according to the fourth exemplary embodiment.

### EXPLANATION OF CODES

100, 100A, 100B, 100C . . . HDMI system as a data processing system
200, 200A, 200B, 200C . . . first radio unit as a data processing device and a computer
201 . . . first CEC-side transmitter/receiver as a data receiver
202 . . . first radio-side transmitter/receiver as a data transmitter
204 . . . first memory as a processing-side memory
204A . . . first memory as a processing-side memory and a return response information memory
206 . . . first ACK response substitution executor
206A . . . report command substitution processor as a return response substitution processor
206B . . . data divider
207C . . . first dummy command transmitter as a first command transmitter
230 . . . report command information as a return response information
300, 310 and 320 . . . first devices
400, 400A, 400B . . . second radio unit as a data transfer device
400C . . . second radio unit as a data transfer device and computer
406, 406B . . . second ACK response substitution executor also functioning as a data transferer
407C . . . second dummy command transmitter as a second command transmitter
500, 510, 520 and 530 . . . second devices
900 . . . CEC frame data as processing data
910 . . . header block as divided data
920 . . . data block as divided data

### BEST MODE FOR CARRYING OUT THE INVENTION

A first exemplary embodiment of the invention will be described below with reference to the attached drawings.

In the first exemplary embodiment, a data processing system according to the invention is exemplified by an HDMI system adapted to perform processing based on a CEC (Consumer Electronics Control) frame format complying with the HDMI (High-Definition Multimedia Interface) standard.

Initially, description will be made on an arrangement of logical address assignment information usable when devices in the HDMI system attempt to acquire respective logical addresses.

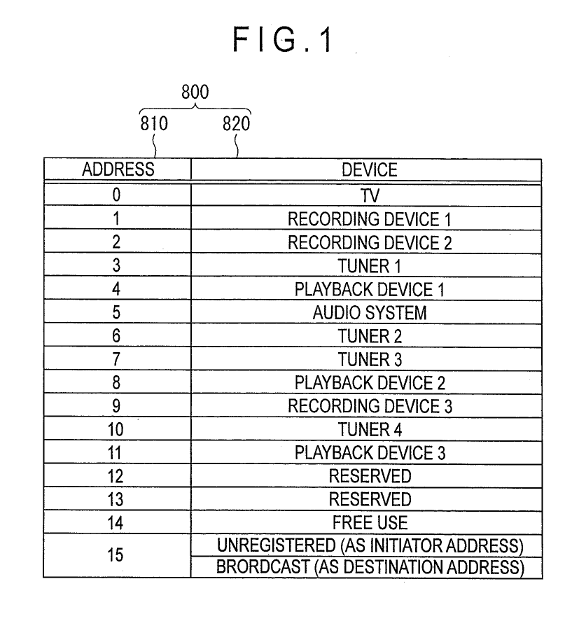

FIG. 1 schematically shows an arrangement of logical address assignment information.

As shown in FIG. 1, logical address assignment information 800 includes address information 810 showing logical addresses represented by numerals 0 to 15 and device information 820 showing devices to which the logical addresses in the address information 810 are to be assigned.

Based on the logical address assignment information 800, devices acquire logical addresses preset depending on the functions, respectively. Each device preferentially acquires the logical address having the smallest value among the logical addresses that are available but have not been acquired by other devices.

### Arrangement of CEC Frame Data

Next, description will be made on an arrangement of CEC frame data usable in the HDMI system.

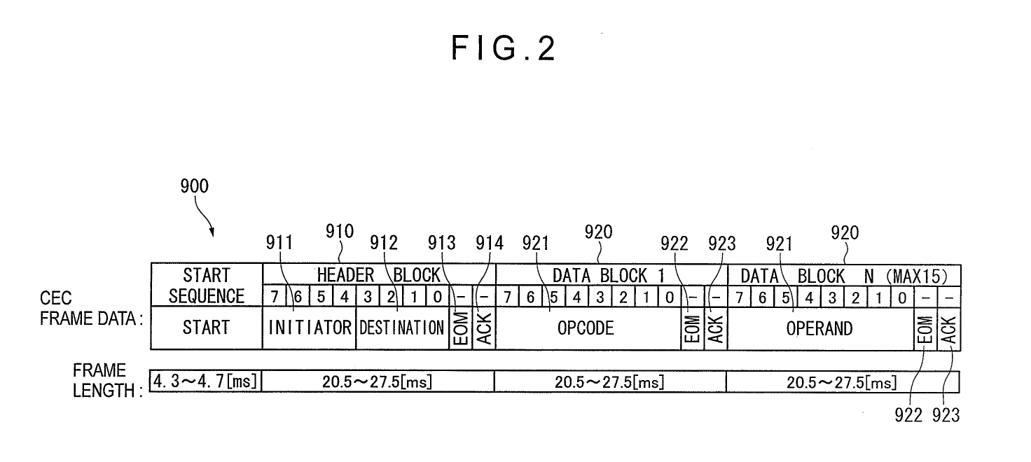

FIG. 2 schematically shows the CEC frame data.

As shown in FIG. 2, CEC frame data 900 as processing data includes a header block 910 and 0 to 15 of variable-length data block(s) 920.

The header block 910 includes a transmission-side logical address area 911, a reception-side logical address area 912, an EOM (End of Message) area 913 and an ACK area 914. Entered in the transmission-side logical address area 911 is a logical address as first device information for specifying an initiator device from which the CEC frame data 900 is sent. Entered in the transmission-side logical address area 912 is a logical address as second device information for specifying a destination device to which the CEC frame data 900 is sent. When the header block 910 is the last block in the CEC frame data 900, information indicating that the header block 910 is the last block is entered in the EOM area 913. The ACK area 914 is usable for performing an ACK response process for reporting the reception of the header block 910. The ACK response process is a process for keeping the ACK area 914 at high impedance (hereinafter also referred to as “HIGH”) during a predetermined period of time when a transmission-side device sends the CEC frame data 900, and fixing the ACK area 914 at low impedance (hereinafter also referred to as “LOW”) during the predetermined period of time when a reception-side device receives the CEC frame data 900. The transmission-side device performs monitoring through this period of time. When it is LOW, the transmission-side device recognizes that the reception-side device received (ACK response). When it is HIGH, the transmission-side device recognizes that the reception-side device did not receive (NACK response).

The data block 920 includes a command area 921, an EOM area 922 and an ACK area 923. In the command area 921, information regarding a command directed to the device is entered. In the EOM area 922 and the ACK area 923, contents similar to those of the EOM area 913 and the ACK area 914 are entered and processed, respectively. A command requiring a response is hereinafter referred to as a “CEC Give command” when described.

### First Exemplary Embodiment

Arrangement of HDMI System

Next, description will be made on an arrangement of the HDMI system in the first exemplary embodiment.

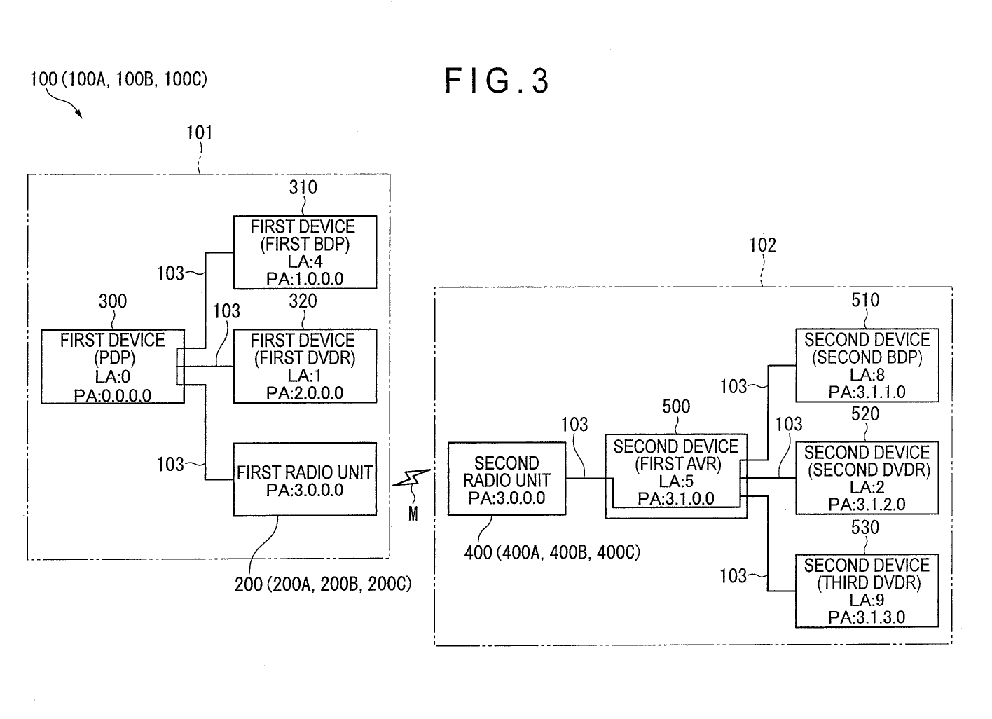

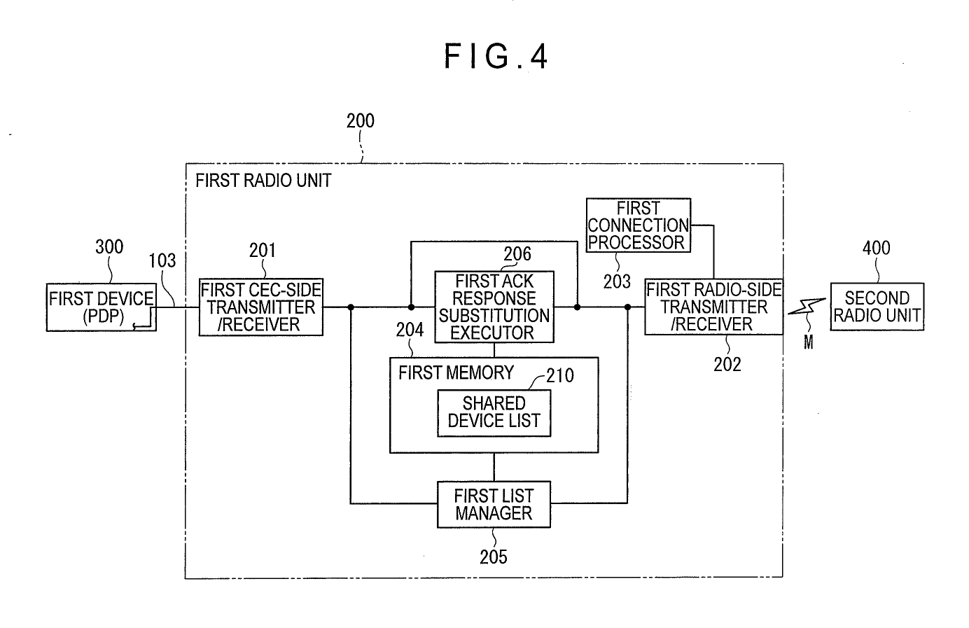

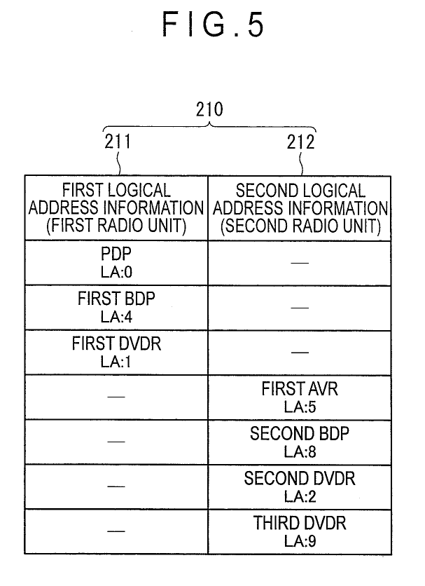

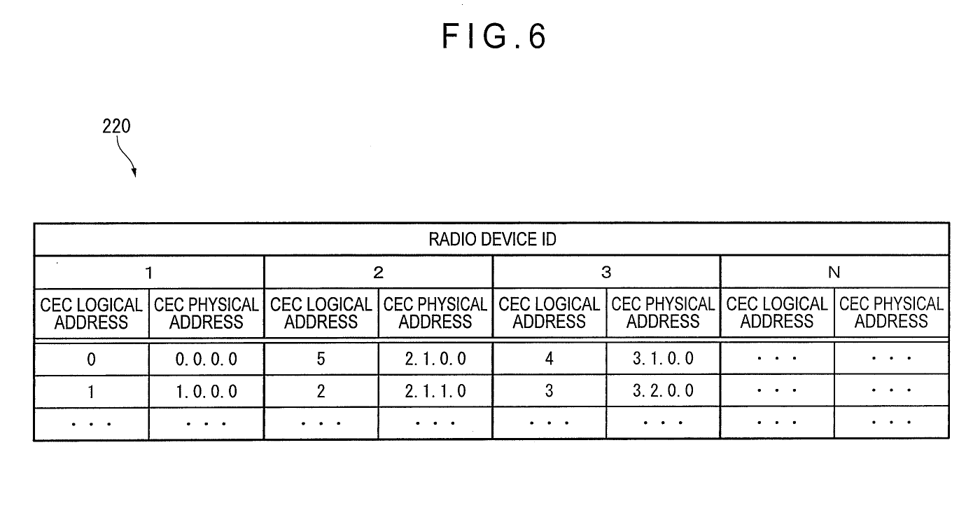

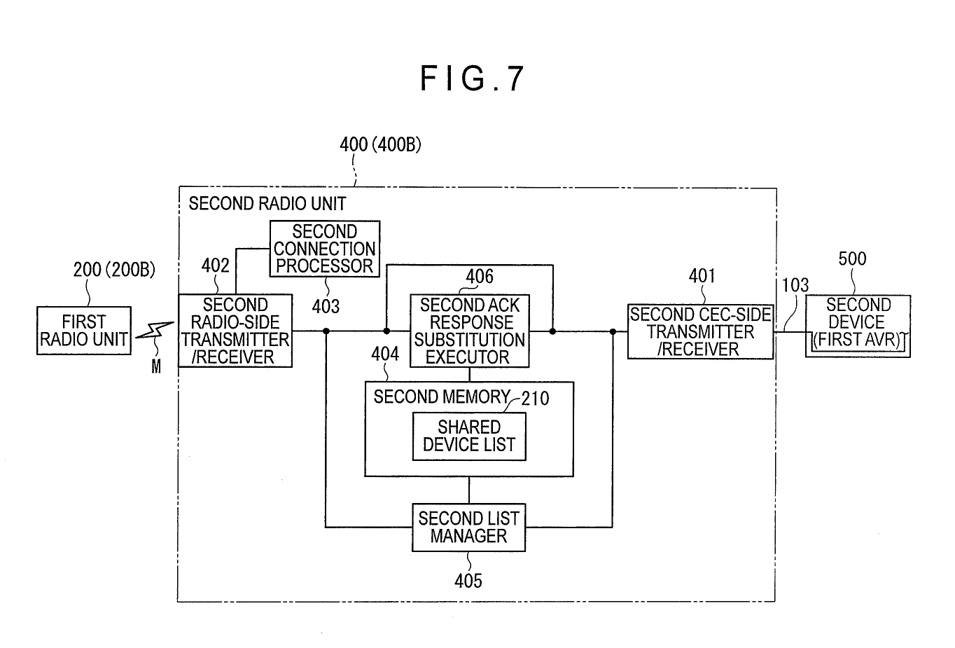

FIG. 3 schematically shows a general arrangement of the HDMI system. FIG. 4 is a block diagram showing a general arrangement of a first radio unit. FIG. 5 schematically shows a shared device list. FIG. 6 schematically shows node information. FIG. 7 is a block diagram showing a general arrangement of a second radio unit.

As shown in FIG. 3, an HDMI system 100 includes a first radio unit 200 as a data processing device and a computer, first devices 300, 310 and 320, a second radio unit 400 as a data transfer device, and second devices 500, 510, 520 and 530.

The first devices 300, 310 and 320, being respectively a PDP (Plasma Display Panel), a first BDP (Blu-ray Disc Player) and a first DVDR (Digital Versatile Disc Recorder), are combined with the first radio unit 200 to provide a first CEC network 101. The second devices 500, 510, 520 and 530, being respectively a first AVR (Audio Visual Receiver), a second BDP, a second DVDR and a third DVDR, are combined with the second radio unit 400 to provide a second CEC network 102.

Each of the first devices 300, 310 and 320 and the second devices 500, 510, 520 and 530 is provided with a function to generate and send the CEC frame data 900, a function to give an ACK response in response to the CEC frame data 900, a function to perform a process in response to a command, a function to send back the result of the process performed in response to a CEC Give command as a CEC Report command, and the like. Here, what is sent back as a CEC Report command is exemplified by the physical address or ASCII code characters representing the manufacturer ID or product series name of the second device 500, 510, 520 or 530.

Each device in the first CEC network 101 is connected to a shared CEC signal line 103. Each device in the second CEC network 102 is connected to a shared CEC signal line 103. Each of the first devices 300, 310 and 320, the first radio unit 200, the second devices 500, 510, 520 and 530, and the second radio unit 400 converts data, information or the like into the CEC frame data 900, and then sends or receives it via the CEC signal line 103.

When recognizing that an ACK response is not given (NACK response) after sending the CEC frame data 900, each of the first devices 300, 310 and 320, the first radio unit 200, the second devices 500, 510, 520 and 530, and the second radio unit 400 sends the same CEC frame data 900 again. When recognizing that an ACK response is not given (NACK response) even after sending the same CEC frame data 900 at a predetermined number of times, each of the first devices 300, 310 and 320, the first radio unit 200, the second devices 500, 510, 520 and 530, and the second radio unit 400 discards this CEC frame data 900.

When CEC frame data 900 is sent by broadcast requiring no specific destination device (in this case, “15” UNREGISTERED/BROADCAST is entered in the reception-side logical address area 912 with reference to the logical address assignment information 800), a device that received the data gives a negative ACK response (i.e., an ACK response having the opposite polarity to that of the above ACK response) and a device that sent the data determines that the transmission has succeeded based on the negative ACK response.

According to the HDMI standard (Version 1.3a), when the CEC frame data 900 is sent and received, it has to be confirmed that the shared CEC signal line 103 is not used for the following time period.
16.8 msec (abbreviated as “ms” hereinafter) or more when the CEC frame data 900 of different contents are sequentially transmitted by the same device.
12 ms or more when a new device transmits the CEC frame data 900.
7.2 ms or more when a transmission of the CEC frame data 900 is failed and the CEC frame data is re-sent.

The first devices 300, 310 and 320 and the second devices 500, 510, 520 and 530 transmit/receive the CEC frame data 900 in accordance with this rule. Sending the Report command by the first devices 300, 310 and 320 and the second devices 500, 510, 520 and 530 in response to the Give command is preferably done within 200 ms after the receipt of the Give command and is uniformly set as 200 ms here.

When recognizing that an ACK response is not given for a predetermined time after sending the CEC frame data 900, each of the first devices 300, 310 and 320 and the second devices 500, 510, 520 and 530 sends the same CEC frame data 900 again. When recognizing that an ACK response is not given even after sending the same CEC frame data 900 for a maximum of five times, each of the first devices 300, 310 and 320 and the second devices 500, 510, 520 and 530 discards this CEC frame data 900.

When it is recognized that the Report command in response to the Give command sent by each of the first devices 300, 310 and 320 and the second devices 500, 510, 520 and 530 has not been received for 1000 ms, each of the first devices 300, 310 and 320 and the second devices 500, 510, 520 and 530 determines that the command is ignored by the destination and aborts the processing related to the transmission command. Generally, the time 1000 ms is counted from the time when the ACK response reporting that the transmitted Give command has been received by the destination is recognized until the time when a corresponding Report command is received.

The Give command and the Report command in response thereto have wide varieties according to the contents thereof. For instance, when the command requests a physical address, the command is <Give Physical address> or <Give Physical address> as a command in response thereto; when the command requests a character name for display, the command is <Give OSD Name> or <Set OSD Name> as a command in response thereto. The command length of the CEC frame data 900 also varies in accordance with the content. The command length of <Give Physical Address> is 59.7 ms: the command length of <Give Physical Address> is 142.2 ms; the command length of <Give OSD Name> is 59.7 ms; and the command length of <Set OSD Name> is, though dependent of the number of characters, 444.7 ms at the maximum (i.e. upper limit of the standard of the CEC frame data 900). In order to show the advantages of the invention to the maximum, it is assumed here that the Give command and the Report command include the header block 910 and fifteen data blocks 920 (upper limit of the standard of the CEC frame data 900) and the command length including a start sequence is uniformly set as 444.7 ms.

Here, in FIG. 3, LA represents a logical address assigned to each device and PA represents a physical address assigned to each device. For instance, the first device (first BDP) 310, which is a playback device, acquires a logical address “4” with reference to the logical address assignment information 800. A physical address “1.0.0.0” is assigned to the first device 310.

For acquiring an own logical address, each device sends a polling command to the devices connected via the shared CEC signal lines 103 on the first and second CEC networks 101 and 102, the polling command not having the data block 920 but only having the header block 910, in which a desired logical address is entered in both the transmission-side logical address area 911 and the reception-side logical address area 912. Then, when receiving a NACK response, the device recognizes that the desired logical address is available and, thus, acquires it. Such a polling command is hereinafter referred to as a polling command [acquirement].

For discovering connected devices on the CEC networks, each device sends a polling command to the devices connected via the shared CEC signal lines 103 on the first and second CEC networks 101 and 102. The polling command not having the data block 920 but only having the header block 910, in which its own logical address is entered in the transmission-side logical address area 911 while a target logical address for connection confirmation is entered in the reception-side logical address area 912. Depending on whether ACK responses or NACK responses are given from the devices, it is recognized whether or not connection to the devices exist. Such a polling command is hereinafter referred to as a polling command [recognition].

The first radio unit 200 is connected to the first CEC network 101 via the shared CEC signal line 103. The first radio unit 200 obtains data such as the CEC frame data 900, information or the like sent from the first device 300 or the like via the CEC signal line 103, and sends it to the second radio unit 400 via a radio medium M. Here, the processing time from reception to transmission is exemplarily 30 ms. The first radio unit 200 also obtains data, information or the like sent from the second radio unit 400 via the radio medium M, and sends it to the first device 300. The first radio unit 200 is provided by various programs and includes a first CEC-side transmitter/receiver 201 as a data receiver, a first radio-side transmitter/receiver 202 as a data transmitter, a first connection processor 203, a first memory 204 as a processing-side memory, a first list manager 205 functioning also as a replaced-information-relating processor, and a first ACK response substitution executor 206, as shown in FIG. 4.

The first CEC-side transmitter/receiver 201 is connected to the first device 300 via the shared CEC signal line 103. The first CEC-side transmitter/receiver 201 converts the CEC frame data 900 from the first device 300 into data or the like, and sends it to the first radio-side transmitter/receiver 202, the first list manager 205 or the first ACK response substitution executor 206. The first CEC-side transmitter/receiver 201 also converts data from the first radio-side transmitter/receiver 202, the first list manager 205 or the first ACK response substitution executor 206 into the CEC frame data 900, and sends it to the first device 300 or the like.

When no ACK response is given in response to the CEC frame data 900 (except if the CEC frame data 900 is broadcasted), the same CEC frame data 900 is sent again. Such a process is repeated at a predetermined number of times until the ACK response is given. When the predetermined number of times is exceeded, this CEC frame data 900 is discarded.

The first radio-side transmitter/receiver 202 converts data from the first connection processor 203, the first list manager 205 or the first ACK response substitution executor 206 into a wireless packet, and sends it to the second radio unit 400. When no wireless packet reception response is obtained from the reception side after the wireless packet is sent, the same wireless packet is sent again. Such a process is repeated at a predetermined number of times until the reception response is obtained. When the predetermined number of times is exceeded, this wireless packet is discarded. The first radio-side transmitter/receiver 202 also converts a wireless packet from the second radio unit 400 into data, and sends it to the first connection processor 203, the first list manager 205 or the first ACK response substitution executor 206.

The first connection processor 203 performs a connecting process to the second radio unit 400.

The first memory 204 stores a shared device list 210 as shown in FIG. 5 and node information as shown in FIG. 6. The shared device list 210 includes first logical address information 211 and second logical address information 212.

Registered in the first logical address information 211 are the first devices 300, 310 and 320 capable of data communication with the first radio unit 200 and the respective logical addresses assigned to these devices. For instance, in FIG. 5, “FIRST 1BDP LA: 4” means that a logical address assigned to the first device 310 is 4.

Registered in the first logical address information 212 are the second devices 500, 510, 520 and 530 capable of data communication with the second radio unit 200 and the respective logical addresses assigned to these devices.

Although the shared device list 210 exemplarily shows only the logical addresses, the shared device list 210 may also show device-specific information of the first and second devices 300, 310, 320, 500, 510, 520 and 530 in association with the logical addresses thereof, the device-specific information including physical addresses, manufacturer IDs, the character strings of product series names, device types, information regarding CEC version, and the like.

The node information 220 is constructed so that logical addresses and physical addresses of a plurality of devices can be registered per each of the wireless device IDs. For instance, when the wireless device ID is 1, a device assigned with a logical address “0” and physical address “0.0.0.0” and another device assigned with a logical address “1” and physical address “1.0.0.0” can be registered therein.

When the first radio unit 200 and the second radio unit 400 are connected to each other to allow data transmission and reception therebetween, when the first radio unit 200 and the first devices 310 and 320 are connected together to allow data transmission and reception therebetween, or when the second radio unit 400 and the second devices 500, 510, 520 and 530 are connected together to allow data transmission and reception therebetween, the first list manager 205 appropriately makes or updates the shared device list 210 in the first memory 204.

The operation of the first list manager 205 will be described below in detail.

When the first ACK response substitution executor 206 obtains the CEC frame data 900 including information to the second device 500, 510, 520 or 530 sent from the first device 300 or the like, the first ACK response substitution executor 206 recognizes the second device 500, 510, 520 or 530 (the destination of the CEC frame data 900) with reference to the logical address in the reception-side logical address area 912 of the header block 910. When the destination is, for instance, the second device 510 registered in the shared device list 210 and the CEC frame data 900 is not a Give command, the first ACK response substitution executor 206 operates to give an ACK response based on an ACK generating signal to report the reception of the CEC frame data 900 by the second device 510. When the destination is, for instance, the second device 510 registered in the shared device list 210 and the CEC frame data 900 is a Give command, the first ACK response substitution executor 206 does not operates to give an ACK response but operates to give an ACK response when it is recognized that the second device 510 received the Give command.

The operation of the first ACK response substitution executor 206 will be described below in detail.

The second radio unit 400, which is connected to the second network 102 via the shared CEC signal line 103, obtains data, information or the like sent from the second device 500 via the CEC signal line 103, and sends it to the first radio unit 200 via the radio medium M. The second radio unit 400 also obtains data, information or the like sent from the first radio unit 200 via the radio medium M, and sends it to the first device 500. The second radio unit 400 is provided by various programs and includes a second CEC-side transmitter/receiver 401, a second radio-side transmitter/receiver 402, a second connection processor 403, a second memory 404 as a transfer-side memory, a second list manager 405 functioning also as a second device information generator, and a second ACK response substitution executor 406 functioning also as a data transferer, as shown in FIG. 7.

The second CEC-side transmitter/receiver 401 is connected to the second device 500 via the shared CEC signal line 103. The second CEC-side transmitter/receiver 401 converts the CEC frame data 900 from the second device 500 into data or the like, and sends it to the second list manager 405 and the second ACK response substitution executor 406. Here, the processing time from reception to transmission is exemplarily 8 ms.

The second CEC-side transmitter/receiver 401 also converts data from the second list manager 405 and the second ACK response substitution executor 406 into the CEC frame data 900, and sends it to the second device 500. When no ACK response is given in response to the CEC frame data 900 (except if the CEC frame data 900 is broadcasted), the same CEC frame data 900 is sent again. Such a process is repeated at a predetermined number of times until the ACK response is given. When the predetermined number of times is exceeded, this CEC frame data 900 is discarded.

The second radio-side transmitter/receiver 402 converts data from the second connection processor 403, the second list manager 405 or the second ACK response substitution executor 406 into a wireless packet, and sends it to the first radio unit 200. When no wireless packet reception response is obtained from the reception side after the wireless packet is sent, the same wireless packet is sent again. Such a process is repeated at a predetermined number of times until the reception response is obtained. When the predetermined number of times is exceeded, this wireless packet is discarded. The second radio-side transmitter/receiver 402 also converts a wireless packet from the first radio unit 200 into data, and sends it to the second connection processor 403, the second list manager 405 or the second ACK response substitution executor 406.

The second connection processor 403 performs a connecting process to the first radio unit 200.

The second memory 404 stores the same shared device list 210 as that of the first memory 204 and the node information 220.

The second list manager 405 appropriately makes or updates the shared device list 210 in the second memory 404 at the same timing as that of the first list manager 205.

The operation of the second list manager 405 will be described below in detail.

The second ACK response substitution executor 406 performs the same process as that of the first ACK response substitution executor 206 of the first radio unit 200.

The operation of the second ACK response substitution executor 406 will be described below in detail.

Operations of HDMI System

Next, description will be made on operations of the HDMI system 100. The first devices 300, 310 and 320 and the second devices 500, 510, 520 and 530 are hereinafter referred to respectively as a PDP 300, a first BDP 310, a first DVDR 320, a first AVR 500, a second BDP 510, a second DVDR 520 and a third DVDR 530, as needed.

Operation when First Radio Unit and Second Radio Unit are Connected

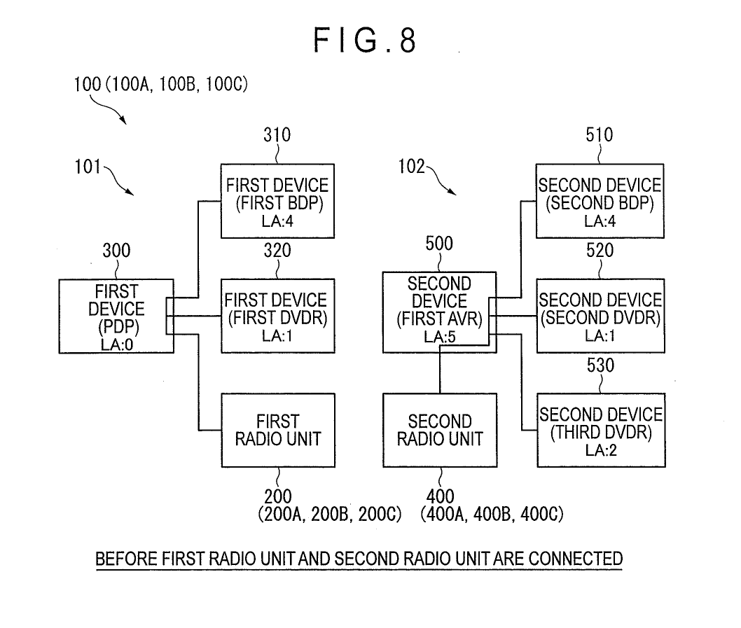

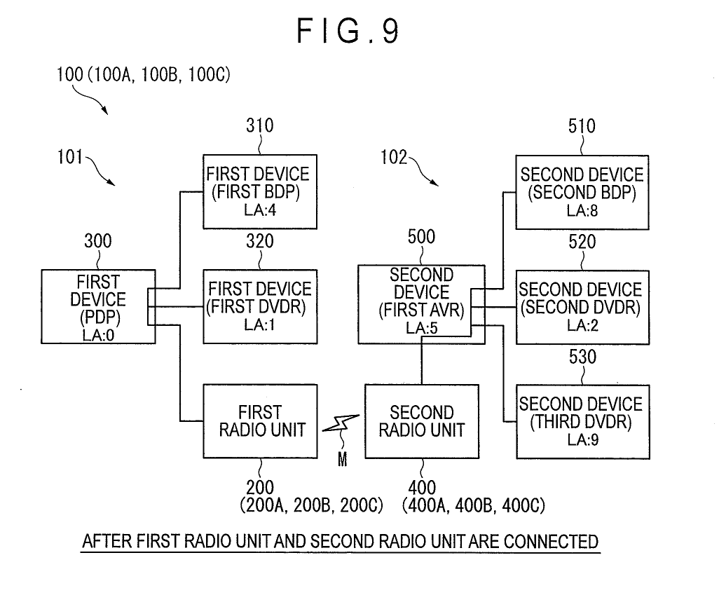

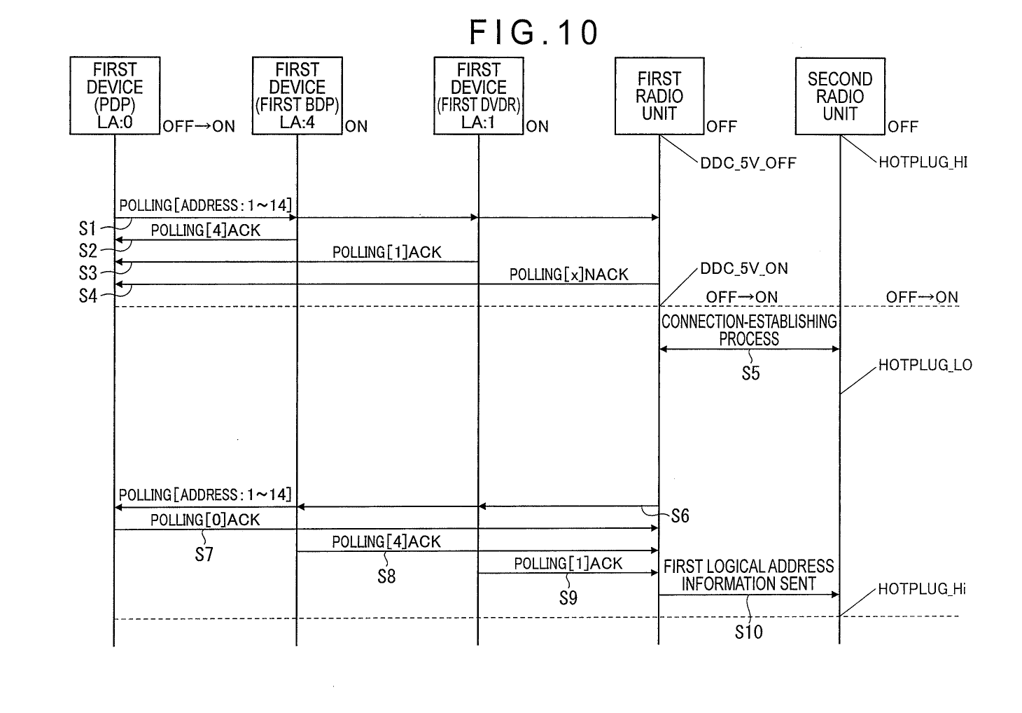

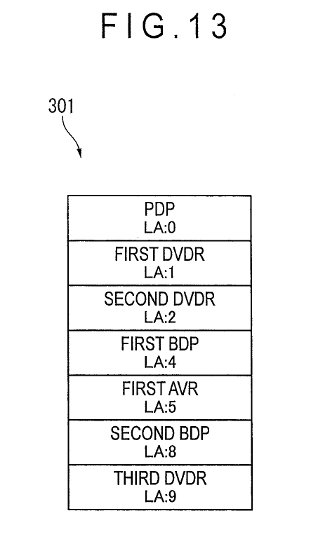

FIG. 8 schematically shows a device connection status and a logical address assignment status before the first radio unit and the second radio unit are connected to each other. FIG. 9 schematically shows a device connection status and a logical address assignment status after the first radio unit and the second radio unit are connected to each other. FIGS. 10 to 12 are timing charts showing an operation performed when the first radio unit and the second radio unit are connected. FIG. 13 schematically shows a PDP recognition list.

In the situation where the first radio unit 200 to which the first devices 300, 310 and 320 are connected is disconnected from the second radio unit 400 to which the second devices 500, 510, 520 and 530 are connected (the radio medium M is not shown) as shown in FIG. 8, for instance, as shown in FIG. 10, when the PDP is switched from OFF to ON while: the first BDP 310 and the first DVDR 320 are ON; the first radio unit 200 is OFF and DDC_{—}5V is OFF (represented by “DDC_{—}5V_OFF” in FIG. 10); and the second radio unit 400 is OFF and the hotplug is set HIGH, the PDP 300 performs a polling command [recognition] process to the first radio unit 200, the first BDP 310 and the first DVDR 320 in order to recognize the device or devices connected after the PDP 300 acquires its logical address “0” (step S1). Specifically, the PDP 300 sequentially sends to the first CEC network 101 the polling command [recognition] of the CEC frame data 900 having the logical address of the PDP 300 entered in the transmission-side logical address area 911 and any one of “1 to 14” entered in the reception-side logical address area 912. The polling command [recognition] processes for the reserved logical addresses “12” and “13” may be omitted.

When the first BDP 310 receives the header block 910 having the logical address “4” entered in the reception-side logical address area 912, the first BDP 310 gives an ACK response for reporting the reception (step S2). Likewise, the first DVDR 320 gives an ACK response for reporting the reception of the header block 910 having the logical address “1” entered in the reception-side logical address area 912 (step S3). The first radio unit 200 gives a NACK response because the first radio unit 200 is OFF (step S4).

Then, when the first and second radio units 200 and 400 are switched from OFF to ON, the DDC_{—}5V of the first radio unit 200 becomes ON. Further, the first connection processor 203 starts an initialization process, thereby providing a communicatable status via the radio medium M as shown in FIG. 9, and also performs a connection-establishing process with the second connection processor 403 of the second radio unit 400 as shown in FIG. 10 (step S5). In the connection-establishing process, an HDMI repeater process is performed. The HDMI repeater process includes a process for switching the hotplug of the second radio unit 400 from HIGH to LOW, a process for reading or writing the EDID of the PDP 300, and the like. Depending on a change in the hotplug status at this time, the second devices 500, 510, 520 and 530 discard respective own logical addresses having been acquired (i.e., the respective logical addresses of these devices become “15” UNREGISTERED).

In order to recognize the connected device or devices, the first list manager 205 of the first radio unit 200 sequentially performs the polling command [recognition] process to the first CEC network 101 in the same manner as the process by the PDP 300 in step S1 (step S6). In response to the polling command [recognition] process, the PDP 300 gives an ACK response for reporting the reception of the header block 910 with the logical address “0” being entered therein, the first BDP 310 gives an ACK response for reporting the reception of the header block 910 with the logical address “4” being entered therein, and the first DVDR 320 gives an ACK response for reporting the reception of the header block 910 with the logical address “1” being entered therein (steps S7, S8 and S9). When the first CEC-side transmitter/receiver 201 confirms these ACK responses, the first list manager 205 generates the first logical address information 211 indicating that the respective logical addresses of the PDP 300, the first BDP 310 and the first DVDR 320 are set at “0”, “4” and “1”, and sends it to the second list manager 405 of the second radio unit 400 (step S10).

Specifically, the first list manager 205 of the first radio unit 200 generates the first logical address information 211 by associating the logical addresses entered in the reception-side logical address area 912 of the header block 910 of the sequentially performed polling command [recognition] process with ACK response/NACK response results in the ACK area 914 performed by the reception-side device(s). The polling command [recognition] process may be omitted for the related logical addresses “12” and “13”.

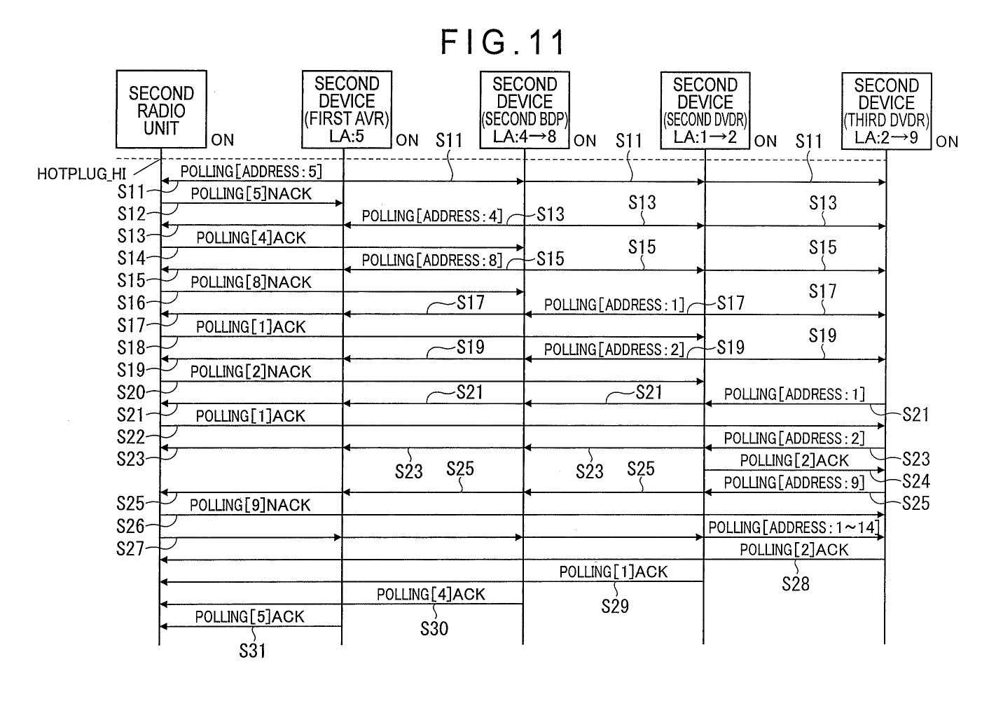

As shown in FIG. 11, the second radio unit 400 switches the hotplug from LOW to HIGH.

Subsequently, in order to reacquire an own logical address, the first AVR 500 enters the logical address “5” and performs the polling command [acquirement] process to the second CEC network 102 (step S11).

The response from each of the second devices 510, 520 and 530 (not shown) is a NACK response for reporting that its logical address is not “5”.

The second ACK response substitution executor 406 of the second radio unit 400 recognizes the absence of the first devices 310 and 320 assigned with the logical address “5” based on the first logical address information 211 from the first list manager 205 via the second CEC-side transmitter/receiver 401, and gives a NACK response (step S12).

When the first AVR 500 recognizes the NACK response from each of the second devices 510, 520 and 530 and the second radio unit 400, the first AVR 500 maintains “5” as its own logical address.

In order to acquire an own logical address, the second BDP 510 enters the logical address “4” and performs the polling command [acquirement] process to the second CEC network 102 in the same manner as the first AVR 500 (step S13).

In response to this polling command [acquirement] process, the each of the second devices 500, 520 and 530 gives a NACK response.

The second ACK response substitution executor 406 recognizes that the logical address of the first BDP 310 is “4” based on the first logical address information 211 via the second CEC-side transmitter/receiver 401, and gives an ACK response (step S14).

When recognizing the ACK response from the second radio unit 400, the second BDP 510, which is a playback device, determines that the logical address “4” has already been acquired by another device. Then, in order to confirm whether or not the logical address “8”, which is assignable to a playback device in accordance with the logical address assignment information 800, is available, the second BDP 510 enters the logical address “8” and again performs the polling command [acquirement] process to the second CEC network 102 (step S15).

In response to this polling command [acquirement] process, the each of the second devices 500, 520 and 530 gives a NACK response.

The second ACK response substitution executor 406 recognizes the absence of the first devices 310 and 320 assigned with the logical address “8” based on the first logical address information 211 via the second CEC-side transmitter/receiver 401, and gives a NACK response for reporting the absence (step S16).

When the second BDP 510 recognizes the NACK response from each of the second devices 500, 520 and 530 and the second radio unit 400, the second BDP 510 acquires and maintains “8” as its own logical address as shown in FIG. 9.

When the second DVDR 520 performs the polling command [acquirement] process for acquiring its own logical address (step S17), the second DVDR 520 recognizes a NACK response from the second devices 500, 510 and 530 and an ACK response from the second radio unit 400 for reporting that the first DVDR 320 is assigned with “1” (step S18). Subsequently, the second DVDR 520, which is a recording device, again performs the polling command [acquirement] process so as to confirm whether or not “2”, which is assignable to a recording device, is available (step S19).

When the second DVDR 520 recognizes the NACK response from each of the second devices 500, 510 and 530 and the second radio unit 400 (step S20), the second DVDR 520 acquires and maintains “2” as its own logical address as shown in FIG. 9.

When the third DVDR 530 performs the polling command [acquirement] process for acquiring its own logical address (step S21), the third DVDR 530 recognizes an ACK response from the second radio unit 400 for reporting that the first DVDR 320 is assigned with “1” (step S22). Next, the third DVDR 530 performs the polling command [acquirement] process for confirming whether or not “2” is available (step S23), and recognizes an ACK response for reporting that the second DVDR 520 is assigned with “2” (step S24). Further, the third DVDR 530 performs the polling command [acquirement] process for confirming whether or not “9” is available (step S25), and recognizes a NACK response from the second radio unit 400 (step S26). Thus, the third DVDR 530 acquires and maintains “9” as its own logical address as shown in FIG. 9.

The second list manager 405 generates temporary second logical address information based on the above processes, the temporary second logical address information indicating that first AVR 500, the second BDP 510, the second DVDR 520 and the third DVDR 530 are respectively assigned with “5”, “8”, “2” and “9”.

Specifically, when receiving the CEC frame data 900 sent from a device connected to the first CEC network 102, the second list manager 405 of the second radio unit 400 recognizes the logical address entered in the transmission-side logical address area 911 and the logical address entered in the reception-side logical address area 912 of the header block 910 of the received CEC frame data 900. When determining that the received CEC frame data 900 is provided for the polling command [acquirement] process for acquiring an own logical address, the second list manager 405 monitors the logical address entered in the reception-side logical address area 912 and also in the transmission-side logical address 911 of the header block 910 as well as an ACK response/NACK response status of the ACK area 914. When this logical address is unregistered in the second logical address information 212 and a NACK response is given, the second list manager 405 generates the temporary second logical address information in association with this logical address. If “15” UNREGISTERED/BROADCAST based on the logical address assignment information 800 is entered in the reception-side logical address area 912, the second list manager 405 ends its operation without performing the above monitoring process.

Subsequently, the second radio unit 400 performs the polling command [recognition] process to the first AVR 500, the second BDP 510, the second DVDR 520 and the third DVDR 530 so as to generate the second logical address information 212 (step S27). When the second CEC-side transmitter/receiver 401 recognizes ACK responses given by each of the first AVR 500, the second BDP 510, the second DVDR 520 and the third DVDR 530 in response to the polling command [recognition] using the header block 910 in which the logical address “5” is entered, the polling command [recognition] using the header block 910 in which the logical address “8” is entered, the polling command [recognition] using the header block 910 in which the logical address “2” is entered, and the polling command [recognition] using the header block 910 in which the logical address “9” is entered (steps S28, S29, S30 and S31), the second list manager 405 compares the obtained result to the temporary second logical address information. When determining that the result coincides with the temporary second logical address information, the second list manager 405 generates the shared device list 210 having the temporary second logical address information as the second logical address information 212 and the first logical address information 211 obtained from the first list manager 205 as shown in FIG. 5, and stores the shared device list 210 in the second memory 404.

If not coincide, while repeating step S28 at an appropriate number of times, the processes of step S11 and the following steps may be again performed after switching the hotplug from HIGH to LOW and keeping the hotplug at LOW for an appropriate period of time. Alternatively, the second logical address information 212 may be provided based on information obtained by performing step S28. In some cases, a process described below in “Operation When There is Logical Address Duplication between First Devices and Second Devices” may be performed.

The second logical address may be generated without generating the temporary second logical address information and, thus, without performing the coincidence determining process.

Specifically, the second list manager 405 of the second radio unit 400 may generate the second logical address information 212 by associating the logical addresses entered in the reception-side logical address area 912 of the header block 910 of the sequentially performed polling command [recognition] process with ACK response/NACK response results in the ACK area 914.

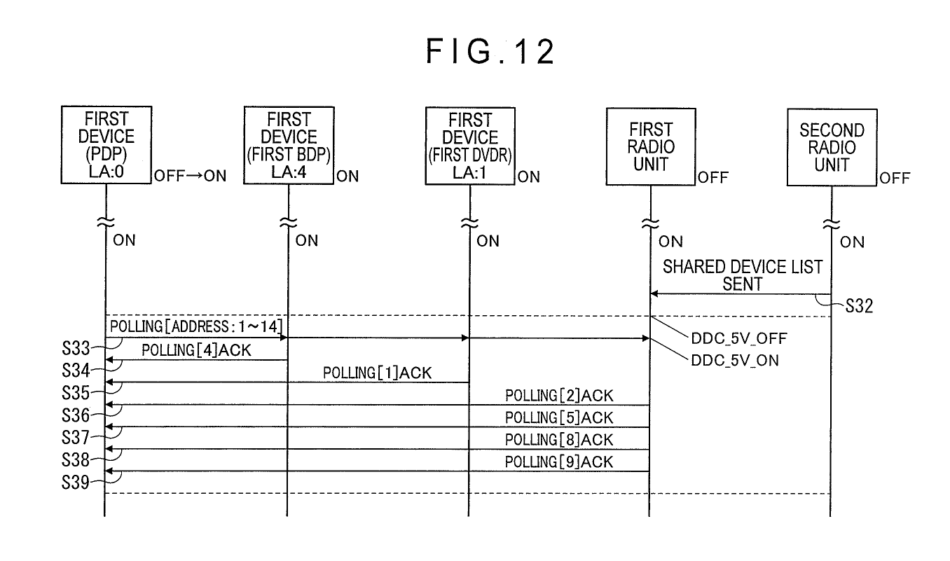

Further, as shown in FIG. 12, the second list manager 405 sends the shared device list 210 to the first list manager 205 of the first radio unit 200 (step S32).

At this time, based on the second logical address information 212, the first list manager 205 may perform and report the polling command [acquirement] process to the first CEC network 101, the polling command [acquirement] process using the header block 910 in which the respective logical addresses “5”, “8”, “2” and “9” of the devices connected to the second CEC network 102 are entered. In such a case, when the first list manager 205 recognizes an ACK response for reporting that at least one of the logical addresses “5”, “8”, “2” and “9” has already been assigned to another device, the first list manager 205 updates the first logical address information 211 after reconfirming at an appropriate number of times, and sends it to the second list manager 405 of the second radio unit 400 while reporting that the logical address has been assigned. The second radio unit 400 may perform the processing again from the process in step S11 after holding the hotplug at LOW from HIGH for an appropriate period of time. In some cases, a process described below in “Operation When There is Logical Address Duplication between First Devices and Second Devices” may be performed. When the first list manager 205 recognizes NACK responses given in response to the polling command [acquirement] process for all the logical addresses “5”, “8”, “2” and “9”, the first list manager 205 recognizes that the acquirement has succeeded. Then, the DDC_{—}5V of the first radio unit 200 is then switched OFF.

The first list manager 205 of the first radio unit 200 instructs the first memory 204 to store the shared device list 210.

Further, the DDC_{—}5V of the first radio unit 200 is switched ON after the elapse of an appropriate period of time.

When the PDP 300 recognizes that the DDC_{—}5V of the first radio unit 200 is switched from OFF to ON, the PDP 300 sequentially performs the polling command [recognition] process to the first CEC network 101 in order to recognize a device or devices connected thereto (step S33).

The first BDP 310 gives an ACK response for reporting that the first BDP 310 is assigned with the logical address “4” and the first DVDR 320 gives an ACK response for reporting that the first DVDR 320 is assigned with the logical address “1” (steps S34 and S35). Further, the first ACK response substitution executor 206 of the first radio unit 200 gives ACK responses for reporting that the second DVDR 520, the first AVR 500, the second BDP 510 and the third DVDR 530 are respectively assigned with the logical addresses “2”, “5”, “8” and “9” based on the shared device list 210 via the first CEC-side transmitter/receiver 201 (steps S36, S37, S38 and S39).

Based on these ACK responses, the PDP 300 recognizes the first devices 310 and 320 and the second devices 500, 510, 520 and 530 to which the CEC frame data 900 can be sent as well as the respective logical addresses thereof, and generates and stores a PDP recognition list 301 shown in FIG. 13.

Operation when Transmitting/Receiving CEC Give Command

Initially, description will be made on operations for transmitting/receiving Give command by the HDMI system 100 in the above first exemplary embodiment.

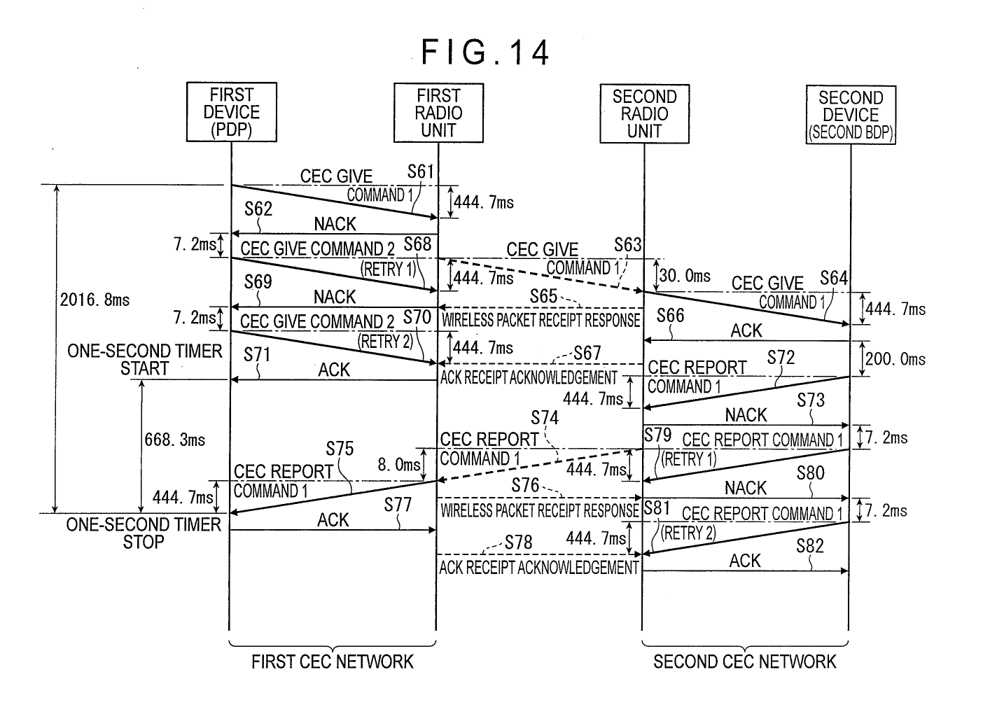

FIG. 14 is a timing chart showing the operation performed when CEC Give command is sent and received.

For instance, the PDP 300 generates the CEC frame data 900 based on the PDP recognition list 301 in order to perform the Give command to the second BDP 510 assigned with the logical address “8”. In the CEC frame data 900, the logical address “0” is entered in the transmission-side logical address area 911 and the logical address “8” is entered in the reception-side logical address area 912. Then, as shown in FIG. 14, the PDP 300 sends the CEC frame data 900 as a CEC Give command to the first radio unit 200 (step S61). 444.7 ms after transmitting the Give command, reception of all of the command is completed by the first radio unit 200. The time required for transmission and receipt of the Give command and Report command is the same (i.e. 444.7 ms) as described above, the description thereof will be omitted hereinafter.

When receiving the Give command, the first ACK response substitution executor 206 of the first radio unit 200 determines whether or not the second BDP 510 having the logical address “8” is connected to the second radio unit 400 based on the second logical address information 212 of the shared device list 210. When the first ACK response substitution executor 206 judges that the second BDP 510 is connected, the first ACK response substitution executor 206 performs an ACK response processing in the ACK area 914 in the header block 910 of the CEC frame data 900 to the PDP 300 (initiator); when information indicating that the current block is the last is not entered in the EOM area 922 of the data block 920, the first ACK response substitution executor 206 performs an ACK response processing in the ACK area 923; and when information indicating that the current block is the last is entered in the EOM area 922 of the data block 920, the first ACK response substitution executor 206 performs a NACK response processing indicating that the Give command has not been received in the ACK area 923 (step S62). Alternatively, the ACK response substitution executor 206 may give a NACK response reporting that Give command has not been received in all of the ACK areas (the ACK area 914 and ACK area 923) in the CEC frame data 900.

The first ACK response substitution executor 206 also sends the Give command to the second radio unit 400 in the form of wireless packet (step S63). 30 ms after transmitting the Give command, reception of all of the command is completed by the second radio unit 400.

When the Give command is received, the second ACK response substitution executor 406 of the second radio unit 400 sends to the second BDP 510 the Give Command in which “8” is entered in the reception-side logical address area 912 (step S64). The second ACK response substitution executor 406 also gives a wireless packet reception response to the first radio unit 200 for reporting the reception of the Give command (step S65).

The second BDP 510 having received the Give command from the second radio unit 400 gives an ACK response for reporting the reception of the Give command (step S66).

The second radio unit 400 having recognized the ACK response from the second BDP 510 sends a signal reporting that the ACK response has been recognized to the first radio unit 200 (step S67).

On the other hand, the PDP 300 having recognized the NACK response in step S62, judging that the second BDP 510 has not received the Give command, starts a retry process in which the same Give command is re-sent for a maximum of five times until the receipt of the Give command by the second BDP 510 is confirmed.

Specifically, when the PDP 300 recognizes the NACK response in step S62, the PDP 300 re-sends the same Give command after 7.2 ms of the recognition in accordance with the communication rule (step S68: retry 1). When the first radio unit 200 receives the Give command, since the first radio unit 200 has not recognized the ACK response from the second BDP 510, the first radio unit 200 again gives a NACK response (step S69). Then, the PDP 300 re-sends the same Give command (step S70: retry 2).

The first ACK response substitution executor 206 of the first radio unit 200 has received the signal in step S67 while receiving the Give command in step S70. Accordingly, the first ACK response substitution executor 206 recognizes that the same Give command as that sent in step S61 has been received by the second BDP 510 (original destination). Then, the first ACK response substitution executor 206 gives an ACK response reporting that the Give command is received by the second BDP (step S71).

The PDP 300 having recognized the ACK response starts a one-second timer (not shown) to start confirmation process for confirming whether or not a Report command is returned within one second (i.e. 1000 ms).

On the other hand, the second BDP 510 starts response process to the Give command after giving ACK response in step S66 and sends the Report command relating to the process to the second radio unit 400 (step S72). The process in step S72 is performed after 200 ms (time required for the response process to the Give command in the second BDP 510) from the process in step S66.

The second ACK response substitution executor 406 of the second radio unit 400 having received the Report command performs determination process for a logical address in the same manner as step S62 and gives a NACK response since the receipt of the Report command by the PDP 300 have not been confirmed (step S73). The second ACK response substitution executor 406 also sends the Report command to the first radio unit 200 in the form of wireless packet (step S74). 8 ms after transmitting the Report command, reception of all of the command is completed by the first radio unit 200.

When receiving the Report command, the first radio unit 200 transfers the Report command to the PDP 300 (step S75). The first radio unit 200 gives a wireless packet reception response to the second radio unit 400 for reporting the reception of the Report command (step S76).

The PDP 300 having received the Report command from the first radio unit 200 stops the one-second timer. At this time, since the required time from the reception confirmation of the Give command by the first radio unit 200 to the receipt of the corresponding Report command is 668.3 ms, i.e. less than one second, the PDP 300 judges that the second BDP 510 has normally executed the command. Then, the PDP 300 gives an ACK response for reporting the reception of the Report command (step S77).

The first radio unit 200 having recognized the ACK response from the PDP 300 sends a signal reporting that the ACK response has been recognized to the second radio unit 400 (step S78).

On the other hand, the second BDP 510 having recognized the NACK response in step S73, judging that the PDP 300 has not received the Report command, starts a retry process in which the same Report command is re-sent for a maximum of five times until the receipt of the Give command by the PDP 300 is confirmed.

Specifically, when the second BDP 510 recognizes the NACK response in step S73, the second BDP 510 re-sends the same Report command after 7.2 ms of the recognition in accordance with the communication rule (step S79: retry 1). When the second radio unit 400 receives the Report command, since the second radio unit 400 has not recognized the ACK response from the PDP 300, the second radio unit 400 again gives a NACK response (step S80). Then, the second BDP 510 re-sends the same Report command (step S81: retry 2).

The second radio unit 400 has received the signal in step S78 while receiving the Report command in step S81. Accordingly, the second radio unit 400 recognizes that the same Report command as that sent in step S72 has been received by the PDP 300 (original destination). Then, the second radio unit 400 gives an ACK response for reporting the reception of the Report command by the PDP 300 (step S82).

Operation when Transmitting/Receiving CEC Give Command in Comparative Example

Next, in order to highlight the advantages of the HDMI system 100 in the above first exemplary embodiment, description will be made on operations for transmitting/receiving Give command in a comparative example in which the invention is not applied.

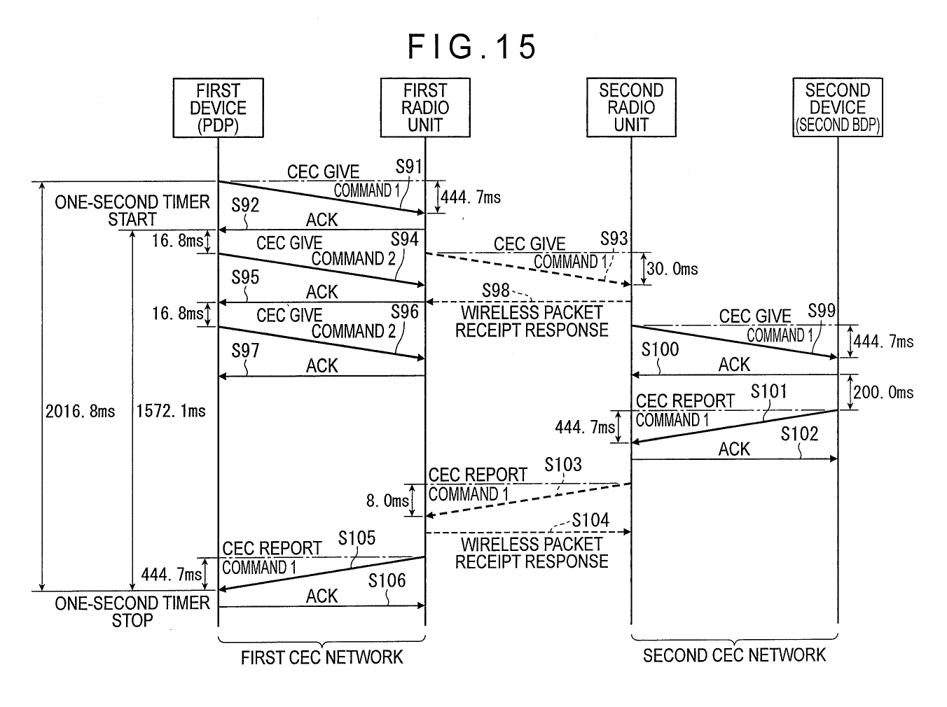

FIG. 15 is a timing chart showing the operation performed when CEC Give command is sent and received in the comparative example.

For instance, the PDP sends the Give command to the first radio unit as shown in FIG. 15 (step S91). When the first radio unit receives the Give command, the first radio unit gives an ACK response for reporting the reception of the Give command (step S92). The first radio unit also sends the Give command to the second radio unit in the form of wireless packet (step S93).

On the other hand, the PDP having recognized the ACK response in step S92 starts the one-second timer. The PDP is then capable of transmitting a new Give command to the first radio unit after 16.8 ms according to the communication rule as shown in steps S94 to S97, as necessary.

When receiving the Give command in step S93, the second radio unit gives a wireless packet reception response to the first radio unit (step S98) and sends the Give command to the second BDP (step S99).

The second BDP having received the Give command gives an ACK response (step S100) and sends a Report command to the second radio unit (step S101). The second radio unit having received the Report command gives an ACK response (step S102) and sends the Report command to the first radio unit (step S103).

The first radio unit having received the Report command gives a wireless packet reception response to the effect to the second radio unit (step S104) and sends the Report command to the PDP (step S105).

The PDP having received the Report command stops the one-second timer. At this time, since the required time from the reception confirmation of the Give command by the first radio unit to the receipt of the corresponding Report command is 1572.1 ms, i.e. more than one second, the PDP judges that the second BDP has not executed the command when one second elapsed and stops the process related to the sent Give command. Then, the PDP gives an ACK response for reporting the reception of the Report command (step S106).

Advantages of First Exemplary Embodiment

As described above, the first exemplary embodiment can achieve the following advantages.

(1) Upon receipt of CEC frame data 900 from a PDP 300, a first radio unit 200 of an HDMI system 100 refers to the content of a reception-side logical address area 912 and recognizes that the destination of this CEC frame data 900 is a second BDP 510 among a plurality of devices connected to a second radio unit 400. When the first radio unit 200 recognizes that the second BDP 510 is connected to the second radio unit 400 based on the second logical address information 212 of the shared device list 210 and the CEC frame data 900 does not contain a Give command, the first radio unit 200 substitutes for the second BDP 510 to give an ACK response to the PDP 300 for reporting the reception of the CEC frame data 900 by the second BDP 510, and sends the CEC frame data 900 to the second BDP 510. When the first radio unit 200 recognizes that the second BDP 510 is connected and the CEC frame data 900 contains a Give command, the first radio unit 200 sends the CEC frame data 900 to the second BDP 510 without giving an ACK response; When the first radio unit 200 recognizes that the second BDP 510 has received the CEC frame data 900, the first radio unit 200 gives an ACK response to the same Give command that is re-sent by the PDP 300 and prompts the PDP 300 to start the timer at that timing.

Accordingly, as compared with a comparative example to which the invention is not applied, the first radio unit 200 can appropriately synchronize the timing for starting the one-second timer with the time at which the second BDP 510 (original destination) has securely received the data in a manner similar to sharing the CEC line. Accordingly, the time from starting the one-second timer after recognizing the receipt of the Give command by the second BDP 510 to receiving the corresponding Report command and stopping the one-second timer can be shortened, so that occurrence of timeout can be restrained and transmission process from the first devices 300, 310 and 320 to the second devices 500, 510, 520 and 530 can be appropriately conducted.

Further, even in a transmission process from the second devices 500, 510, 520 and 530 to the first devices 300, 310 and 320, since the first radio unit 200 and the second radio unit 400 perform similar operations, an appropriate operation can also be ensured.

Further, in an action related to the sequence of Give/Report commands between the networks having different CEC lines (i.e. the first and second networks 101 and 102), the retry process by the PDP 300 and the second BDP 510 can restrain new command transmission that is not essential to the first and the second networks 101 and 102 in order to synchronize the related commands. Further, imbalance of communication traffic caused on account of separation of the CEC signal line 103 can also be restrained.

### Second Exemplary Embodiment

Next, description will be made on an HDMI system according to a second exemplary embodiment of the invention.

It should be understood that, in the description on the second exemplary embodiment and the below-described third and fourth exemplary embodiments, the components similar to those in the first exemplary embodiment will be denoted by the same reference numerals and name to omit the description therefor where appropriate.

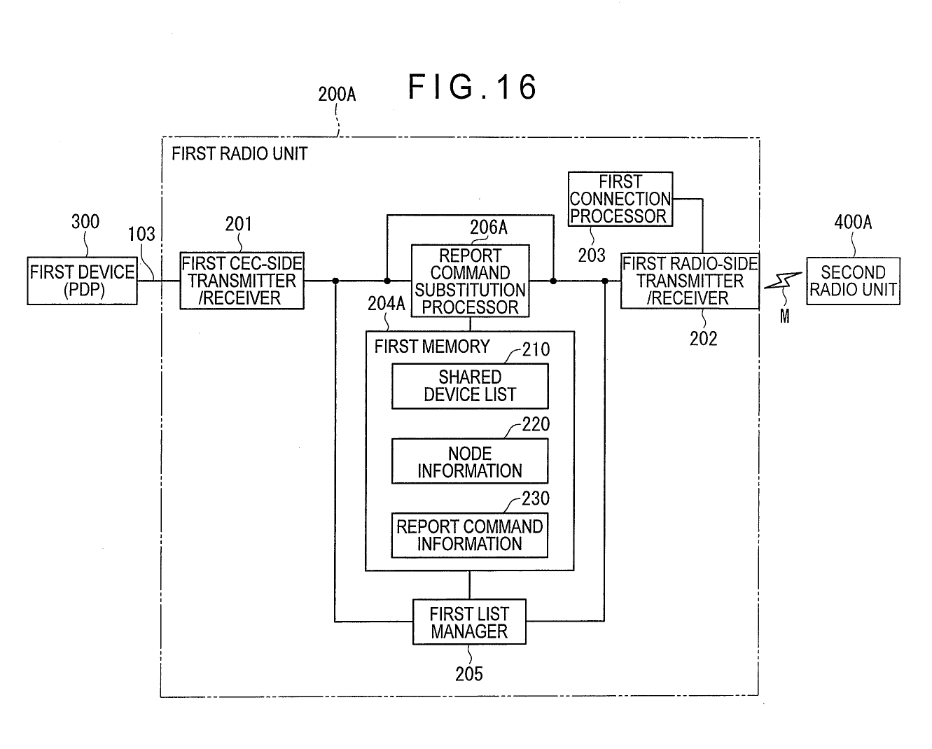

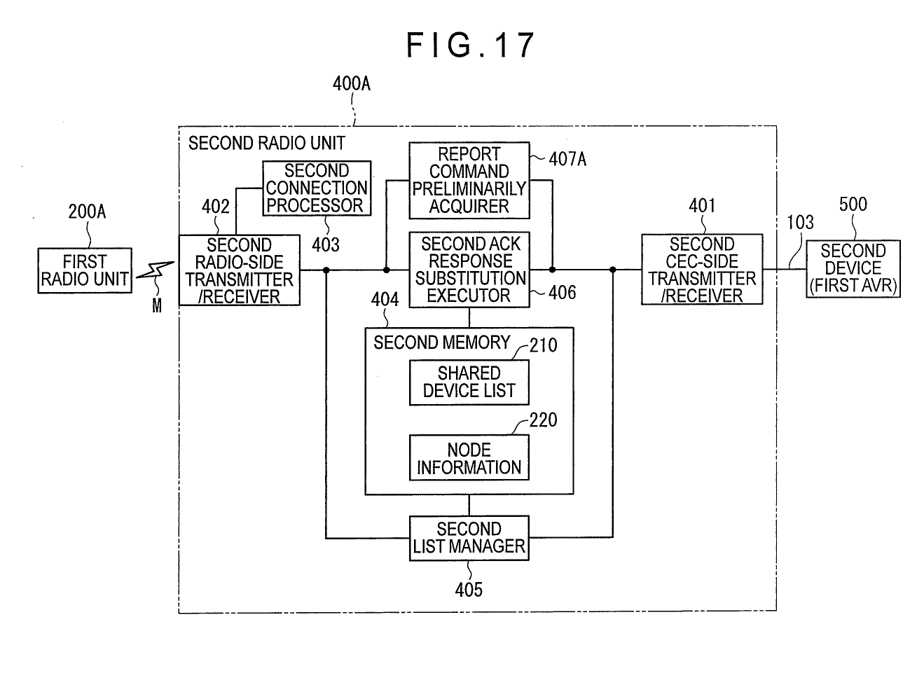

FIG. 16 is a block diagram showing a general arrangement of a first radio unit. FIG. 17 is a block diagram showing a general arrangement of a second radio unit.

As shown in FIG. 3, an HDMI system 100A includes a first radio unit 200A as a data processing device and a computer in place of the first radio unit 200 in the HDMI system 100 and a second radio unit 400A as a data transfer device in place of the second radio unit 400.

As shown in FIG. 16, the first radio unit 200A is provided with a first CEC-side transmitter/receiver 201, a first radio-side transmitter/receiver 202, a first connection processor 203, a first memory 204A as a processing-side memory and return response information memory, a first list manager 205 and a report command substitution processor 206A as a return response substitution processor that are provided by various programs.

The first memory 204A stores a shared device list 210, node information 220 and report command information 230 as return response information.

The report command information 230 stores a content for specifying the second devices 500, 510, 520 and 530 (destination of a predetermined Give command), the content of the Give command and a content of a Report command corresponding to the Give command from the second devices 500, 510, 520 and 530. For instance, the report command information 230 stores a logical address for specifying the second BDP 510 (destination), that the Give command requests transmission of manufacturer's ID and product series name and that the manufacturer of the second BDP 510 is “A company” and the product series name is “B-1.”

Incidentally, though a single report command information 230 is illustrated in FIG. 16, a plurality of report command information 230 may also be stored. Alternatively, the report command information 230 may store a content for specifying one of the first devices 300, 310 and 320 from which the Give command is sent. Further, the first radio unit 200A may be provided with a return response information memory independent of the first memory 204A and the report command information 230 may be stored in the return response information memory.

The report command substitution processor 206A receives information on the Give command sent from the second radio unit 400A and on the second devices 500, 510, 520 and 530 and a Report command corresponding to the Give command. The report command substitution processor 206A then generates the report command information 230 based on the various information and store it in the first memory 204A.

When the report command substitution processor 206A acquires the CEC frame data 900 sent from the PDP 300, the report command substitution processor 206A recognizes the destination of the CEC frame data 900. When the destination is, for instance, the second BDP 510 registered in the shared device list 210 and the CEC frame data 900 is not a Give command, the report command substitution processor 206A performs the same process as the first ACK response substitution executor 206 without performing special process and sends it to the second BDP 510.

When the destination is registered in the shared device list 210 and the CEC frame data 900 is a Give command, the report command substitution processor 206A performs the same process as the first ACK response substitution executor 206 and determines whether or not the report command information 230 corresponding to the destination and the Give command is stored in the first memory 204A. The same process as the first ACK response substitution executor 206 refers to a process for giving an ACK response reporting that the original destination, i.e. the second BDP 510 has received the Give command.

Then, when judging that the Report command information 230 is stored, the report command substitution processor 206A sends the content of the Report command stored in the report command information 230 to the PDP 300 in place of the second BDP 510 (destination) and sends the Give command to the second BDP 510 through the first radio-side transmitter/receiver 202. On the other hand, when judging that the Report command information 230 is not stored, the report command substitution processor 206A sends the Give command to the second BDP 510 without sending the Report command to the PDP 300.

As shown in FIG. 17, the second radio unit 400A is provided with a report command preliminarily acquirer 407A provided by various programs in addition to the components of the second radio unit 400.

The report command preliminarily acquirer 407A independently generates a Give command before the Give command is sent from the first devices 300, 310 and 320 and sends the Give command to preliminarily acquire the Report command from all of the second devices 500, 510, 520 and 530. Then, the report command preliminarily acquirer 407A sends the information for specifying one of the second devices 500, 510, 520 and 530 and the Report command to the first radio unit 200A.

Incidentally, the Report command may be preliminarily acquired on only one of the second devices 500, 510, 520 and 530. Further, the preliminarily acquired Report command may be related to all of the Give commands that are sent and received by the HDMI system 100A or may be related to a part of the Give commands. Further, the report command preliminarily acquirer 407A may generate the report command information 230 in which the content of the Give command, the information for specifying one of the second devices 500, 510, 520 and 530 and the content of the Report command are associated and send the report command information 230 to the first radio unit 200A.

Operations of HDMI System

Next, description will be made on operations for transmitting/receiving Give command by the HDMI system 100A.

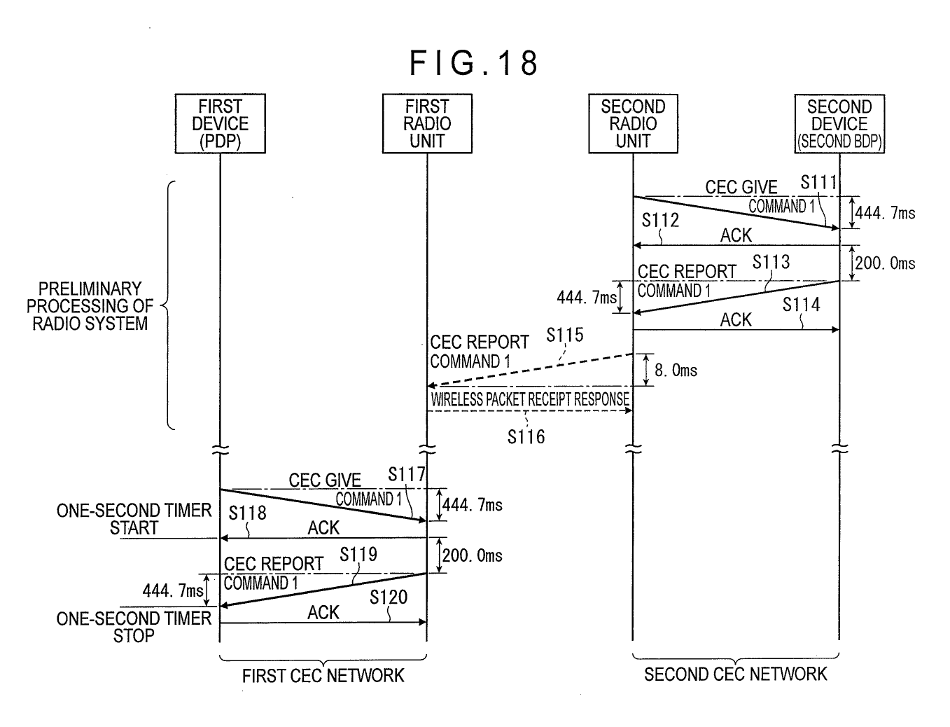

FIG. 18 is a timing chart showing the operation performed when CEC Give command is sent and received.

As shown in FIG. 18, the second radio unit 400A sends primary Give command to all of the second devices 500,510,520 and 530 (step S111). When receiving the Give command, the second devices 500, 510, 520 and 530 respectively give ACK responses (step S112). Further, each of the second devices 500, 510, 520 and 530 performs a process in response to the Give command and sends the Report command to the second radio unit 400A (step S113).

When the second radio unit 400A receives the Report command, the second radio unit 400A gives an ACK response for reporting the reception of the Report command (step S114). Further, the second radio unit 400A sends the Report command to the first radio unit 200A together with information for specifying one of the second devices 500, 510, 520 and 530 (step S115).

The first radio unit 400 having received the Report command and the like gives a wireless packet reception response to the second radio unit 400A for reporting the reception (step S116). The first radio unit 200A stores the report command information 230 based on the received various information in the first memory 204A.

A preliminary process of a wireless system provided by the first and the second radio units 200A and 400A has been described above.

After the preliminary process, for instance, the PDP 300 sends the predetermined Give command to the first radio unit 200A (step S117).

When the first radio unit 200A receives the Give command, the first radio unit 200A gives an ACK response for reporting the reception of the Give command by the destination (step S118). The PDP 300 having recognized the ACK response starts the one-second timer.

The first radio unit 200A determines whether or not the report command information 230 corresponding to the Give command and the destination is stored in the first memory 204A. When it is determined that the report command information 230 is stored, the first radio unit 200A sends the Report command of the report command information 230 to the PDP 300 (step S119). Though not illustrated, the Give command may be sent to the second devices 500, 510, 520 and 530 or the like (destination) via the second radio unit 400A.

When it is determined that the report command information 230 is not stored, the Report command is sent to the second devices 500, 510, 520 and 530 or the like (destination) via the second radio unit 400A.

When receiving the Report command, the PDP 300 gives an ACK response and stops the one-second timer (step S120).

Advantages of Second Exemplary Embodiment

As described above, the second exemplary embodiment can achieve the following advantages.

(2) The second radio unit 400A of the HDMI system 100A sends a predetermined Give command to all of the second devices 500, 510, 520 and 530 to acquire the Report command before the Give command is sent from the first devices 300, 310 and 320. Then, the second radio unit 400A sends the Give command, the information for specifying one of the second devices 500, 510, 520 and 530 and the Report command to the first radio unit 200A. The first radio unit 200A stores the report command information 230 based on the sent various information in the first memory 204A. When the report command information 230 related to the Report command in response to the Give command received from, for instance, the PDP 300 and the destination is stored in the first memory 204A, the first radio unit 200A gives an ACK response reporting that the Give command is received by the destination in place of the destination and sends the Report command of the report command information 230 to the PDP 300.

Accordingly, the first radio unit 200A can equalize the time from starting the one-second timer to stopping the one-second timer by the PDP 300 with the time required when a CEC line is shared, so that generation of timeout can be restrained and an appropriate Report command in response to the Give command can be sent to the PDP 300. Thus, the transmission process from the first devices 300, 310 and 320 to the second devices 500, 510, 520 and 530 can be appropriately performed.

Further, even in a transmission process from the second devices 500, 510, 520 and 530 to the first devices 300, 310 and 320, since the first radio unit 200A and the second radio unit 400A perform similar operations, an appropriate operation can also be ensured.

Further, in an action related to the sequence of Give/Report commands between the networks having different CEC lines (i.e. the first and second networks 101 and 102), the invention offers a processing of the Report command within a time equal to a time in an arrangement sharing a CEC line, new command transmission that is not essential to the first and the second networks 101 and 102 can be restrained and the related commands can be synchronized. Further, imbalance of communication traffic caused on account of separation of the CEC signal line 103 can also be restrained.

### Third Exemplary Embodiment

Next, description will be made on an HDMI system according to a third exemplary embodiment of the invention.

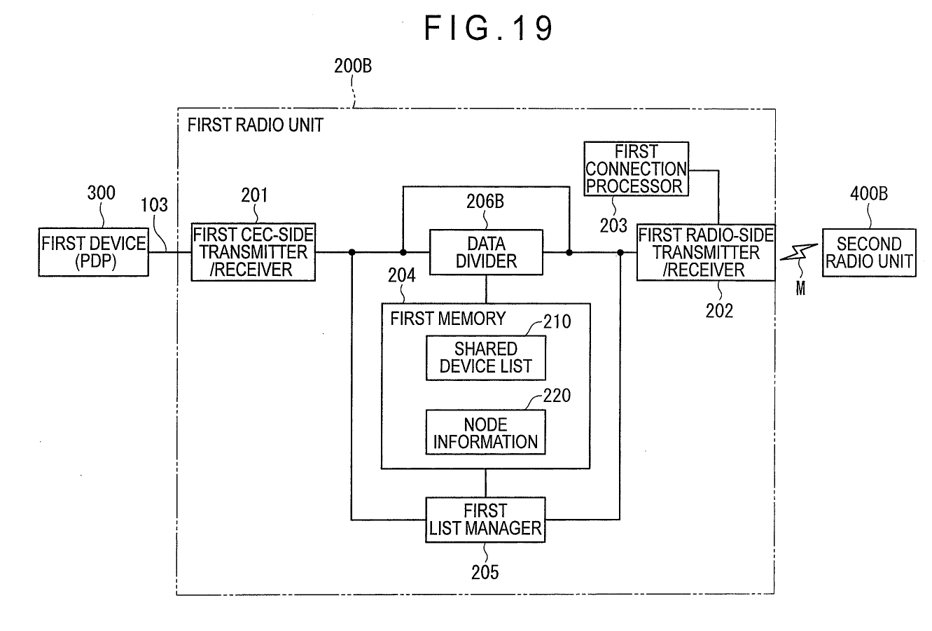

FIG. 19 is a block diagram showing a general arrangement of a first radio unit.

As shown in FIG. 3, an HDMI system 100B includes a first radio unit 200B as a data processing device and a computer in place of the first radio unit 200 in the HDMI system 100 and a second radio unit 400B as a data transfer device in place of the second radio unit 400.

As shown in FIG. 19, the first radio unit 200B is provided with a first CEC-side transmitter/receiver 201, a first radio-side transmitter/receiver 202, a first connection processor 203, a first memory 204, a first list manager 205 and a data divider 206B that are provided by various programs.

The data divider 206B receives the CEC frame data 900 from the first devices 300, 310 and 320 and divides the CEC frame data 900 into blocks. Specifically, the data divider 206B divides the CEC frame data 900 into a header block 910 as a divided data and a data block 920 as a divided data. When the CEC frame data 900 contains, for instance, five data blocks 920, the data divider 206B divides the CEC frame data 900 into five data blocks 920. The data divider 206B separately converts the divided header block 910 and the data block 920 into wireless packets and sends them to the second radio unit 400B. When the packets are sent, the data divider 206B firstly sends the header block 910 and subsequently sends the data block(s) 920 in an order corresponding to the closeness of the position relative to the header block 910 in the pre-divided data structure.

As shown in FIG. 7, the second radio unit 400B is provided with a second ACK response substitution executor 406B (serving also as a data transferer) provided by various programs in place of the second ACK response substitution executor 406 of the second radio unit 400.

When the second ACK response substitution executor 406B receives the divided header block 910 and the data block 920 from the first radio unit 200B, the second ACK response substitution executor 406B reconstructs the divided header block 910 and the data block 920 into the CEC frame data 900 and transfer the CEC frame data 900 to the second devices 500, 510, 520 and 530 (destination).

Operation when Transmitting/Receiving CEC Frame Data

Initially, description will be made on operations for transmitting/receiving Give command by the HDMI system 100B in the above third exemplary embodiment.

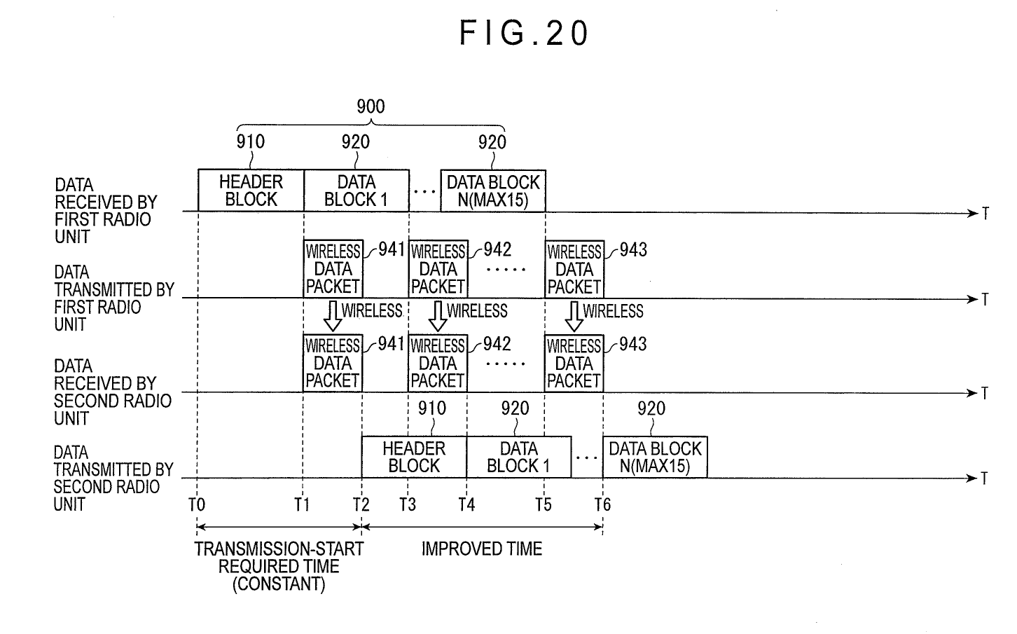

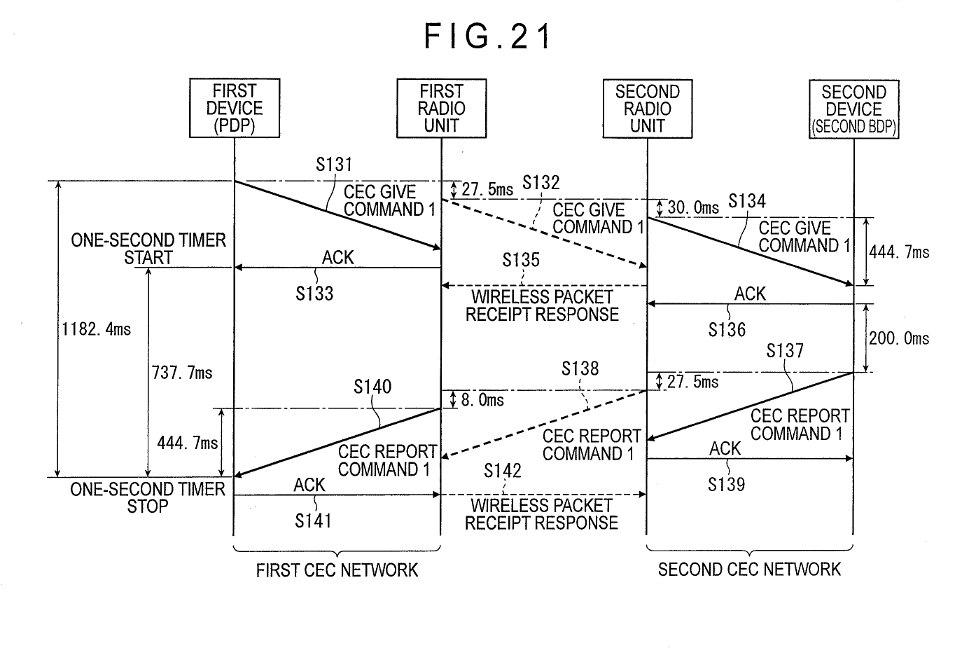

FIG. 20 is a timing chart showing the operation of the first and second radio units performed when CEC frame data is sent and received. FIG. 21 is a timing chart showing an operation of an HDMI system performed when CEC Give command is sent and received in an example employing the above method.

As shown in FIG. 20, the first radio unit 200B receives CEC frame data 900 from, for instance, the PDP 300.

Specifically, the first radio unit 200B starts receiving the header block 910 of the CEC frame data 900 at time point T0.

Subsequently, when the first radio unit 200B finishes receiving the header block 910 at time point T1, the first radio unit 200B recognizes the logical address of the destination based on the second logical address information 212 of the shared device list 210. When it is recognized that the destination is connected, the first radio unit 200B performs an ACK response process to the destination device in the ACK area 914 in the header block 910 of the CEC frame data 900 and divides the header block 910 from the CEC frame data 900 to send the divided header block 910 in a wireless packet 941 to the second radio unit 400B. The first radio unit 200B also starts receiving the first header block 920 at time point T1. At this time, the first radio unit 200B performs an ACK response process in the ACK area 923 in the data block 920 in a manner similar to that of the header block 910. Further, when receiving the wireless packet 941, the second radio unit 400B returns the wireless packet 941 to the header block 910 at time point T2.

Further, the second radio unit 400B restores the header block 910 into a form of the CEC frame data and starts transmission to, for instance, the second BDP 510 at time point T2.

Next, when the first radio unit 200B finishes receiving the first data block 920 at time point T3, the first radio unit 200B divides the data block 920 from the CEC frame data 900 and sends the data block 920 to the second radio unit 400B in the form of a wireless packet 942. The first radio unit 200B also starts receiving the third header block 910 (not shown) at time point T3. Further, the second radio unit 400B receives the wireless packet 942 and reconstructs the wireless packet 942 into the first data block 920 at time point T3.

The second radio unit 400B starts sending the data block 920 to the second BDP 510 at time point T4.

Next, when the first radio unit 200B finishes receiving the Nth (N is 3 to 15) data block 920 at time point T5, the first radio unit 200B sends the data block 920 to the second radio unit 400B in the form of a wireless packet 943. The second radio unit 400B receives the wireless packet 943 and reconstructs the wireless packet 943 into the Nth data block 920 at time point T5.

The second radio unit 400B starts sending the data block 920 to the second BDP 510 at time point T6.

When the wireless packets 941, 942 and 943 are respectively sent from the first radio unit 200B to the second radio unit 400B, the same wireless packets may be sent for a plurality of times or an error-correction system such as a coding/decoding technique may be used in order to enhance reliability of the transmission. Alternatively, information for clearly identifying the order, the number of the block or the like of the header block 910 and the respective data blocks 920 by the second radio unit 400B may be added before sending the data.

Further, the transmission timing from the second radio unit 400B to the destination device such as the second BDP 510 may be started when the second radio unit 400B recognizes that information reporting that the current block is the last data in the CEC frame data 900 is entered in the EOM areas 913 and 923. Further, at this time, whether or not the wireless packets 941, 942 and 943 are received in the normal order and normal number or blocks and the CEC frame data 900 has been normally reconstructed may be verified based on additional information such as the block order and the number of blocks and, when it is judged that the CEC frame data 900 is not normal, reconstruction process or re-send request may be made based on the additional information.

Further, the block that is divided and sent is not restricted to a single block unit such as the header block 910 and the respective data blocks 920 in the structure of the CEC frame data 900, but a combination of several blocks or a unit of one or several bits may be subjected to the wireless packet transmission.

In FIG. 20, the time for sending the header block 910 from the first device (PDP) 300 to the first radio unit 200B, i.e. from time point T0 to time point T1, is defined as the first time. Similarly, the time for sending the first data block 920 from the first device 300 to the first radio unit 200B, i.e. from time point T1 to time point T3, is defined as the second time. The time for sending the wireless packet 941 corresponding to the header block 910 from the first radio unit 200B to the second radio unit 400B, i.e. from time point T1 to time point T2, is defined as the third time. Similarly, the time for sending the wireless data packet 942 corresponding to the first data block 920 from the first radio unit 200B to the second radio unit 400B, i.e. from time point T3 to time point T4, is defined as the fourth time. The third time is shorter than the first time corresponding thereto. Similarly, the fourth time is shorter than the second time corresponding thereto. The time for sending the header block 910 from the second radio unit 400B to the second device (second BDP) 510, i.e. the time from time point T2 to time point T4, is equal to the first time. Similarly, the time for sending the first data block 920 from the second radio unit 400B to the second device 510 is equal to the second time. In this exemplary embodiment, the time required for sending the header data block 910 and the respective data blocks 920 from the first device 300 to the first radio unit 200B is equal to the second time; the time required for sending the wireless data packets corresponding to the header data block 910 and the respective data blocks 920 from the first radio unit 200B to the second radio unit 400B is equal to the fourth time; and the time required for sending the header data block 910 and the respective data blocks 920 from the second radio unit 400B to the second device 510 is equal to the second time.

As described above, the sum of time required for dividing the CEC frame data 900 into a plurality of wireless data packets and sending the wireless data packets from the first radio unit 200B to the second radio unit 400B is made shorter than the time required for sending the CEC frame data 900. In other words, the communication speed of the wireless data packet is set so that the time required for sending the respective wireless data packets becomes shorter than the time required for sending a part of the CEC frame data 900 corresponding to the wireless data packets. Consequently, the original CEC frame data 900 can be reconstructed from the plurality of wireless data packets by the second radio unit 400B. According to the above process, the communication delay time caused between the first radio unit 200B and the second radio unit 400B can be set as a time required for sending a part of the CEC frame data 900 corresponding to a single wireless data packet.

Next, description will be made on operations of the entire HDMI system 100B.

As shown in FIG. 21, the PDP 300 sends the CEC frame data 900 related to Give command to the first radio unit 200B (step S131).

When the first radio unit 200B completes the receipt of the header block 910 in the CEC frame data 900, the first radio unit 200B performs an ACK response process in the ACK area 914 in the header block 910. Further, the first radio unit 200B divides the header block 910 from the CEC frame data 900 and starts sending the header block 910 to the second radio unit 400B at 27.5 ms (equal to the block length of the header block 910) after starting the transmission in the step S131 (step S132). Subsequently, each time the first radio unit 200B finishes receiving each of the data blocks 920, the first radio unit 200B sequentially sends the divided data block 920 to the second radio unit 400B together with the ACK response process of the ACK area 923 in the data block 920. When the CEC frame data 900 is completely received, the first radio unit 200B gives an ACK response in the ACK area 923 in the last block (a block in which information indicating that the current block is the last is entered in the EOM area 922) reporting that the entire CEC frame data 900 is received (step S133).

The PDP 300 having recognized the ACK response starts the one-second timer.

On the other hand, when the divided header block 910 is completely received, the second radio unit 400B starts sending the header block 910 to the second BDP 510 at 30 ms after starting the transmission in step S132 (step S134). The second radio unit 400B sequentially sends the data block 920 to the second BDP 510 each time the data block 920 is completely received. When all of the divided data are completely received, the second radio unit 400B gives a wireless packet reception response to the first radio unit 200B for reporting the reception of the data (step S135).

The second BDP 510 sequentially performs an ACK response process in the ACK areas 914 and 923 after starting the transmission in step S134. When all of the divided data is completely received at 444.7 ms after the ACK response process, the second BDP 510 gives an ACK response for the ACK area 923 in the last block (step S136). Then, 200 ms after the ACK response in step S136, the second BDP 510 sends the CEC frame data 900 of the Report command corresponding to the Give command to the second radio unit 400B (step S137).

When receiving the header block 910, the second radio unit 400B performs an ACK response process in the ACK area 914, and also starts sending the header block 910 to the first radio unit 200B at 27.5 ms after starting the transmission in step S137 (step S138). Subsequently, each time the second radio unit 400B finishes receiving each of the data blocks 920, the second radio unit 400B sequentially sends the data block 920 to the first radio unit 200B together with the ACK response process in the ACK area 923. When all of the divided data are completely received, the second radio unit 400B gives an ACK response for the ACK area 923 in the last block (step S139).

On the other hand, when the divided header block 910 is completely received, the first radio unit 200B starts sending the header block 910 to the PDP 300 at 8 ms after starting the transmission in step S138 (step S140). The first radio unit 200B sequentially sends the data block 920 to the PDP 300 each time the data block 920 is completely received. The first radio unit 200B having received all the data stops the one-second timer. At this time, since the required time from the reception confirmation of the Give command by the first radio unit 200B to the receipt of the corresponding Report command is 737.7 ms, i.e. less than one second, the PDP 300 judges that the second BDP 510 normally executed the command. Then, the PDP 300 gives an ACK response (step S141).

The first radio unit 200B having recognized the ACK response from the PDP 300 gives to the second radio unit 400B a wireless packet reception response reporting that the ACK response has been recognized (step S142).

Operation when Transmitting/Receiving CEC Frame Data in Comparison Example

Next, in order to highlight the advantages of the HDMI system 100B in the above third exemplary embodiment, description will be made on operations for transmitting/receiving the CEC frame data in a comparative example in which the invention is not applied.

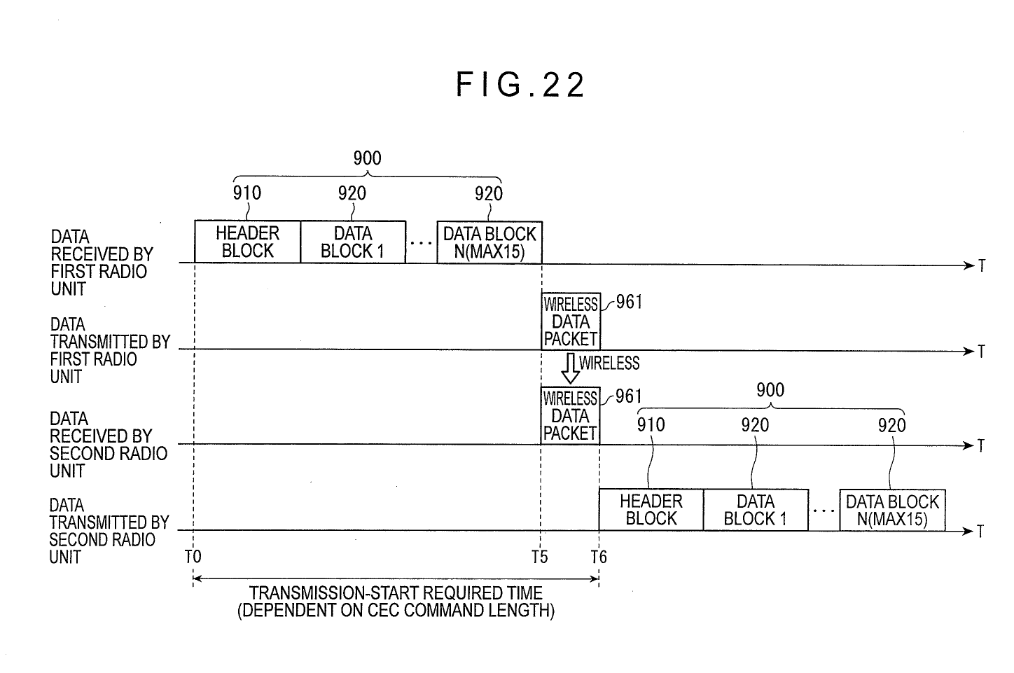

FIG. 22 is a timing chart showing the operation of the first and second radio units performed when CEC frame data is sent and received in the comparative example.

As shown in FIG. 22, the first radio unit starts receiving the header block 910 of the CEC frame data 900 at time point T0. When the first radio unit finishes receiving the first data block 920 at time point T5, the first radio unit sends the entire CEC frame data 900 to the second radio unit in the form of a single wireless packet 961 without dividing the CEC frame data 900. The second radio unit completely receives the wireless packet 961 at time point T6 and sends to the second BDP after restoring the wireless packet 961 into the CEC frame data 900.

As described above, in the comparative example shown in FIG. 22, the required time (referred to as transfer-start required time hereinafter) counted from the time when the first radio unit starts sending the header block 910 to the second radio unit until the time the second radio unit starts transferring the header block 910 to the second devices 500, 510, 520 and 530 is a time between the time point T0 and T6, which is proved to be dependent on the data amount of the CEC frame data 900. In contrast, in the HDMI system 100B according to the second exemplary embodiment shown in FIG. 20, the transfer-start required time is a time between time point T0 and time point T2, which is constant irrespective of the data amount of the CEC frame data 900.

Advantages of Third Exemplary Embodiment

As described above, the third exemplary embodiment can achieve the following advantages.

(3) When receiving the Give command from the PDP 300, the first radio unit 200B of the HDMI system 100B divides the CEC frame data 900 into the header block 910 and the data block 920. Then, the first radio unit 200B converts the CEC frame data separately into wireless packets and sends the packet to the second radio unit 400B. Each time the second radio unit 400B receives wireless packets from the first radio unit 200B, the second radio unit 400B reconstructs the wireless packets into the CEC frame data 900 in the order of the reception and sends it to, for instance, the second BDP 510.

Accordingly, the HDMI system 100B can reduce the transfer-start required time as compared with the comparative example in which the invention is not applied, so that all of the CEC frame data 900 can be received by the second BDP 510 (destination) at a constant early timing irrespective of the data amount of the CEC frame data 900. Accordingly, since all the CEC frame data 900 can be received by the PDP 300 at an earlier timing than that in the comparative example, the time required for stopping the one-second timer can be reduced and generation of timeout can be restrained. In addition, transmission/receipt response for all CEC communication can be improved. Thus, the transmission process from the first devices 300, 310 and 320 to the second devices 500, 510, 520 and 530 can be appropriately performed.

Further, even in a transmission process from the second devices 500, 510, 520 and 530 to the first devices 300, 310 and 320, since the first radio unit 200B and the second radio unit 400B perform similar operations, an appropriate operation can also be ensured.

Further, generally in CEC communication between the networks having different CEC lines (i.e. the first and second networks 101 and 102), the invention allows an operation only by an addition of a predetermined processing time as compared with an arrangement sharing the CEC line, new command transmission that is not essential to the first and the second networks 101 and 102 can be restrained, related commands can be synchronized and deterioration of transmission/receipt response can be minimized. Further, imbalance of communication traffic caused on account of separation of the CEC signal line 103 can also be restrained.

### Fourth Exemplary Embodiment

Next, description will be made on an HDMI system according to a fourth exemplary embodiment of the invention.

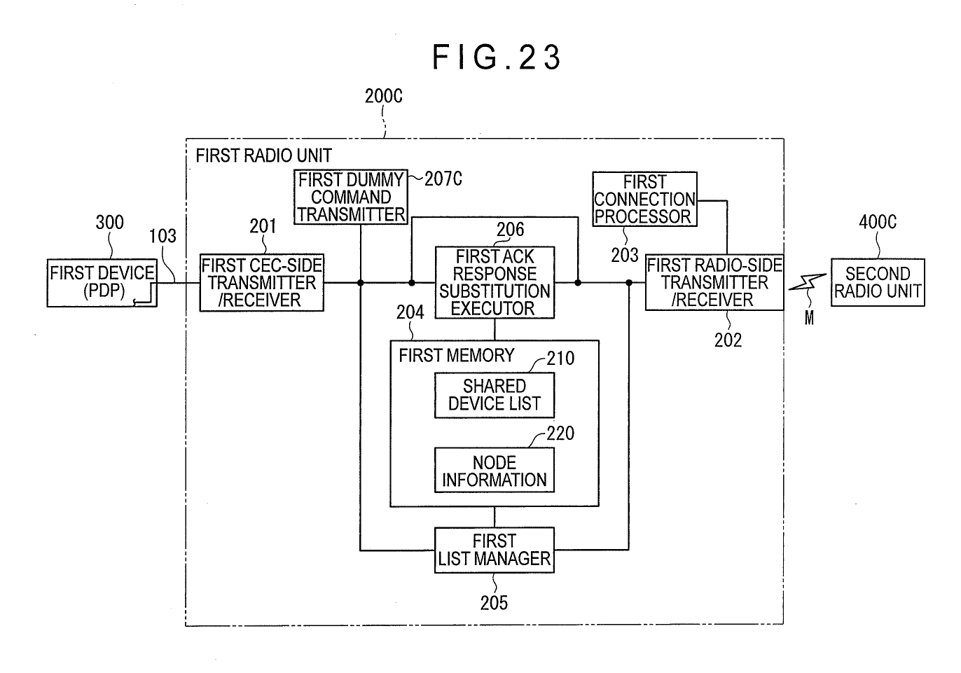

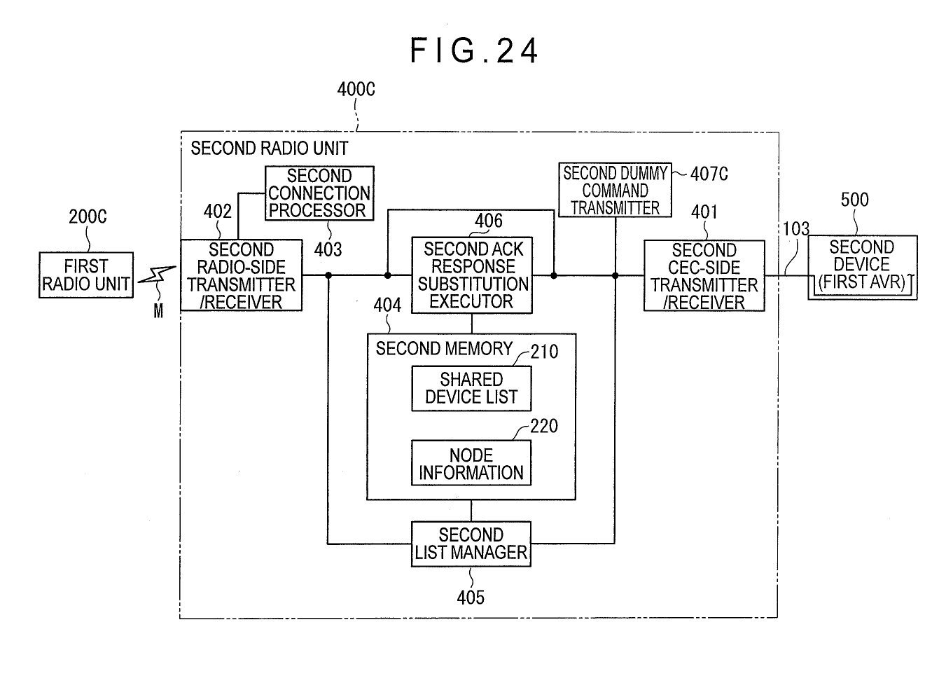

FIG. 23 is a block diagram showing a general arrangement of a first radio unit. FIG. 24 is a block diagram showing a general arrangement of a second radio unit.

As shown in FIG. 3, an HDMI system 100C includes a first radio unit 200C as a data processing device and a computer in place of the first radio unit 200 in the HDMI system 100 and a second radio unit 400C as a data transfer device and a computer in place of the second radio unit 400.

As shown in FIG. 23, the first radio unit 200C is provided with a first CEC-side transmitter/receiver 201, a first radio-side transmitter/receiver 202, a first connection processor 203, a first memory 204, a first list manager 205, a first ACK response substitution executor 206 and a first dummy command transmitter 207C as a first command transmitter that are provided by various programs.

When the first dummy command transmitter 207C recognizes that the first ACK response substitution executor 206 gives an ACK response in place of, for instance, the second BDP 510 when receiving a Give command directed to the second BDP 510, the first dummy command transmitter 207C sends a dummy command to all of the first devices 310, 320 (i.e. to the first CEC network 101) connected to the PDP 300 including the initiator. Further, each time the first dummy command transmitter 207C recognizes an ACK response or a NACK response in response to the dummy command, the first dummy command transmitter 207C re-sends the dummy command to all of the first devices 300, 310 and 320. Further, when the first dummy command transmitter 207C recognizes that a Report command in response to a Give command is received by the first radio-side transmitter/receiver 202, the first dummy command transmitter 207C stops sending the dummy command.

The dummy command sent by the first dummy command transmitter 207C and the below-described second dummy command transmitter 407C referred to herein is as follows.

Specifically, the dummy command is a command for sending a polling command that is supposed to cause no trouble in a CEC communication on a CEC network to the CEC network connected via the shared CEC signal line to recognize the presence or absence of the respective devices based on the ACK response and NACK response of the respective devices. The polling command is used by the respective devices for identifying the device(s) connected to the CEC network. The polling command is provided by a CEC frame data 900 that includes no data block 920 but has the header block 910, in which its own logical address is entered in the transmission-side logical address area 911 while a target logical address for connection confirmation is entered in the reception-side logical address area 912. The dummy command is not restricted to the above arrangement but may be provided in any manner as long as a trouble is not caused in a CEC communication on a CEC network.

As shown in FIG. 24, the second radio unit 400C is provided with a second CEC-side transmitter/receiver 401, a second radio-side transmitter/receiver 402, a second connection processor 403, a second memory 404, a second list manager 405, a second ACK response substitution executor 406 and a second dummy command transmitter 407C as a second command transmitter that are provided by various programs.

When the second dummy command transmitter 407C recognizes that the second ACK response substitution executor 406 gives an ACK response in place of, for instance, the PDP 300 when receiving a Report command directed to the PDP 300, the second dummy command transmitter 407C sends a dummy command to all of the second devices 510, 520 and 530 (i.e. to the second CEC network 102) connected to the first AVR 500 including the initiator of the Report command. Further, each time the second dummy command transmitter 407C recognizes an ACK response or a NACK response in response to the dummy command, the second dummy command transmitter 407C re-sends the dummy command to all of the second devices 500, 510, 520 and 530. Further, when the second dummy command transmitter 407C recognizes that the Report command is received by the initiator of the Give command, the second dummy command transmitter 407C stops sending the dummy command.

Operations of HDMI System

Next, description will be made on operations for transmitting/receiving Give command by the HDMI system 100C.

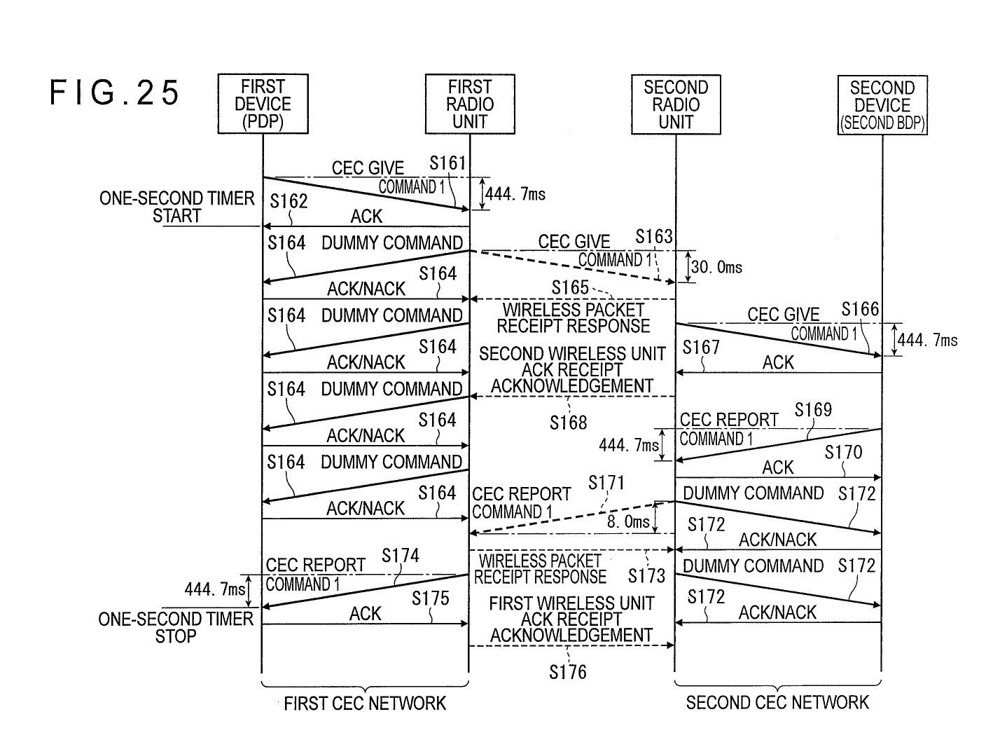

FIG. 25 is a timing chart showing the operation performed when CEC Give command is transmitted and received.

For instance, the PDP 300 sends the Give command for the second BDP 510 to the first radio unit 200C as shown in FIG. 25 (step S161).

Then, the first ACK response substitution executor 206 of the first radio unit 200C having received the Give command gives an ACK response reporting that the Give command is received (step S162). The PDP 300 having recognized the ACK response starts the one-second timer.

The first radio unit 200C also sends the Give command to the second radio unit 400C (step S163). Then, the first dummy command transmitter 207C of the first radio unit 200C sends a dummy command to all of the first devices 300, 310 and 320 until the Report command is received by the first radio-side transmitter/receiver 202 and repeats an ACK response or NACK response processes in response to the dummy command (step S164). By performing the process in step S164, the first devices 300, 310 and 320, for instance, are unable to send a new Give command to the first radio unit 200C.

On the other hand, the second radio unit 400C having received the Give command gives a wireless packet reception response to the first radio unit 200C for reporting the reception of the Give command (step S165). Further, the second radio unit 400C sends the Give command to the second BDP 510 (step S166).

The second radio unit 400C having recognized the ACK response from the second BDP 510 (step S167) sends a signal reporting that the Give command has been received by the second BDP 510 to the first radio unit 200C (step S168).

Then, the second BDP 510 generates a Report command in response to the Give command after the ACK response process and sends the Report command to the second radio unit 400C (step S169).

The second radio unit 400C having received the Report command gives an ACK response (step S170) and sends the Report command to the first radio unit 200C (step S171). Then, the second dummy command transmitter 407C of the second radio unit 400C sends a dummy command to all of the second devices 500, 510, 520 and 530 until the second dummy command transmitter 407C recognizes that the Report command is received by the PDP 300, and repeats an ACK response or NACK response process in response to the dummy command (step S172). By performing the process in step S172, the second devices 500, 510, 520 and 530, for instance, are unable to send a new Give command to the second radio unit 400C.

On the other hand, when the first radio-side transmitter/receiver 202 receives the Report command, the first radio unit 200C gives a wireless packet reception response to the second radio unit 400C for reporting the reception of the Report command (step S173). Further, when the first dummy command transmitter 207C recognizes that the Report command in response to the Give command is received by the first radio-side transmitter/receiver 202, the first dummy command transmitter 207C stops sending the dummy command.

Further, the first radio unit 200C also sends the Report command to the PDP 300 (step S174). Subsequently, when receiving the Report command, the PDP 300 stops the one-second timer and gives an ACK response (step S175). Then, the first radio unit 200C sends a signal reporting that the ACK response has been recognized to the second radio unit 400C (step S176).

When recognizing the signal reporting that an ACK response is recognized by the first radio unit 200C, the second dummy command transmitter 407C of the second radio unit 400C stops the transmission process of the dummy command judging that the Report command has been received by the PDP 300. By stopping the transmission of the dummy command, the second devices 500, 510, 520 and 530 are able to freely send, for instance, a Give command as necessary in accordance with communication start rule when the other devices are not communicating.

Advantages of Fourth Exemplary Embodiment

As described above, the fourth exemplary embodiment can achieve the following advantages.

(4) When receiving the Give command from, for instance, the PDP 300, the first radio unit 200C of the HDMI system 100C gives an ACK response. Then, the first radio unit 200C sends a Give command to the second BDP 510 and sends a dummy command to all of the first devices 300, 310 and 320.

Accordingly, by making all of the first devices 300, 310 and 320 perform a process in response to the dummy command after sending the Give command, the first radio unit 200C can keep the first devices 300, 310 and 320 from sending, for instance, a new Give command before the Report command is sent back. Accordingly, non-essential command transmission caused on account of the transmission of new Give command to the second radio unit 400C as shown in, for instance, steps S94 to S97 before the Report command is sent back can be restrained, thereby allowing synchronization of a sequence of related command actions. Further, imbalance of communication traffic caused on account of separation of the CEC signal line 103 between the first and the second CEC networks 101 and 102 can also be restrained.

(5) When receiving a Report command, the first radio unit 200C stops sending the dummy command to allow the transmission and receipt of various data by the first devices 300, 310 and 320.

Accordingly, the Report command can be rapidly sent to the PDP 300 from which the Give command is sent.

(6) The second radio unit 400C of the HDMI system 100C having received the Report command sends the Report command to the first radio unit 200C and sends a dummy command to all of the second devices 500, 510, 520 and 530.

Accordingly, since all of the second devices 500, 510, 520 and 530 has to perform a process in response to the dummy command after sending the Report command, the second radio unit 400C can keep the second devices 500, 510, 520 and 530 from, for instance, sending a new Give command. Accordingly, non-essential command transmission caused on account of the transmission of new Give command to the first radio unit 200C as shown in, for instance, steps S94 to S97 before it is recognized that the Report command is received by the PDP 300 can be restrained, thereby allowing synchronization of a sequence of related command actions. Further, imbalance of communication traffic caused on account of separation of the CEC signal line 103 between the first and the second CEC networks can also be restrained.

(7) When recognizing a receipt of a Report command by the PDP 300, the second radio unit 400C stops sending the dummy command to allow the transmission and receipt of various data by the second devices 500, 510, 520 and 530.

Accordingly, a new Report command can be rapidly sent by the second devices 500, 510, 520 and 530.

### Modifications of Exemplary Embodiments

Incidentally, the scope of the invention is not restricted to the above first to fourth exemplary embodiments, but includes the following modifications as long as an object of the invention can be achieved.

The first CEC network 101 may only include the PDP 300 and the second CEC network 102 may only include at least one of the second BDP 510, the second DVDR 520 and the third DVDR 530.

In the fourth exemplary embodiment, the dummy command may be sent by the first and second radio units 200C and 400C for a preset number of times.

In each of the first and second CEC networks 101, 102, devices more than those in the above exemplary embodiments may be connected.

Each of the first CEC-side transmitter/receiver 201 of the first radio unit 200 and the second CEC-side transmitter/receiver 401 of the second radio unit 400 may be connected to the CEC signal line 103 at one or more wired medium connectors. For instance, when an HDMI cable is used as the wired medium, each of the first and second radio units 200 and 400 may be provided with a plurality of HDMI connectors.

More than one of the processes described in the first to fourth exemplary embodiments may be combined to enhance the advantages thereof.

The replacing process may be applied not only to the logical addresses but also to any information unique to connected devices, such as the physical addresses.

A wired medium such as an optical fiber or an HDMI cable may be used for transmission and reception of data between the first radio unit 200 and the second radio unit 400.

While the functions are realized in the form of programs in the above description, the functions may be realized in any form, e.g., a hardware such as a circuit board, an element such as an IC (Integrated Circuit), or the like. In view of easy handling and promotion of the use, the functions are preferably stored and read from programs or separate storage media.

The arrangements and the operating procedures for realizing the invention may be appropriately modified as long as an object of the invention can be achieved.

### Advantages of Exemplary Embodiments

As described above, in the above exemplary embodiment, when the first radio unit 200 recognizes that the CEC frame data 900 does not include a Give command from the PDP 300, the first radio unit 200 substitutes for the second BDP 510 to give an ACK response to the PDP 300 for reporting the reception of the CEC frame data 900 by the second BDP 510, and sends the CEC frame data 900 to the second BDP 510. Further, when the first radio unit 200 recognizes that the CEC frame data 900 includes a Give command, the first radio unit 200 sends the CEC frame data 900 to the second BDP 510 with the ACK response. When the first radio unit 200 recognizes that the second BDP 510 receives the CEC frame data 900, the second BDP 510 gives an ACK response to the same Give command that is re-sent from the PDP 300 and prompts the PDP 300 to start a timer at this timing.

Accordingly, as compared with an arrangement to which the invention is not applied, the first radio unit 200 can appropriately synchronize the timing for starting the one-second timer with the time at which the second BDP 510 (original destination) has securely received the data in a manner similar to sharing the CEC line. Accordingly, the time from starting the one-second timer after recognizing the receipt of the Give command by the second BDP 510 to receiving the corresponding Report command and stopping the timer can be shortened, so that occurrence of timeout can be restrained and transmission process from the first devices 300, 310 and 320 to the second devices 500, 510, 520 and 530 can be appropriately conducted.

Further, even in a transmission process from the second devices 500, 510, 520 and 530 to the first devices 300, 310 and 320, since the first radio unit 200 and the second radio unit performs similar operations, an appropriate operation can also be ensured.

Further, in an action related to the sequence of Give/Report command between the networks having different CEC lines (i.e. the first and second networks 101 and 102), the retry process by the PDP 300 and the second BDP 510 can restrain new command transmission that is not essential to the first and the second networks 101 and 102 in order to synchronize the related commands. Further, imbalance of communication traffic caused on account of separation of the CEC signal line 103 can also be restrained.

In another exemplary embodiment, the first radio unit 200A stores the report command information 230 based on the various information sent from the second radio unit 400A in the first memory 204A. When the report command information 230 related to the Report command in response to the Give command received from the PDP 300 and the destination is stored in the first memory 204A, the first radio unit 200A gives an ACK response reporting that the Give command is received by the destination in place of the destination and sends the Report command of the report command information 230 to the PDP 300.

Accordingly, the first radio unit 200A can equalize the time from starting the one-second timer stopping the one-second timer by the PDP 300 with the time required when a CEC line is shared, so that generation of timeout can be restrained and an appropriate Report command in response to the Give command can be sent to the PDP 300. Thus, the transmission process from the first devices 300, 310 and 320 to the second devices 500, 510, 520 and 530 can be appropriately performed.

Further, even in a transmission process from the second devices 500, 510, 520 and 530 to the first devices 300, 310 and 320, since the first radio unit 200A and the second radio unit 400A perform similar operations, an appropriate operation can also be ensured.

Further, in an action related to the sequence of Give/Report commands between the networks having different CEC lines (i.e. the first and second networks 101 and 102), the invention offers a processing of the Report command within a time equal to an arrangement sharing a CEC line, new command transmission that is not essential to the first and the second networks 101 and 102 can be restrained and the related commands can be synchronized. Further, imbalance of communication traffic caused on account of separation of the CEC signal line 103 can be simultaneously restrained.

In still another exemplary embodiment, when receiving the Give command from the PDP 300, the first radio unit 200B of the HDMI system 100B divides the CEC frame data 900 into the header block 910 and the data block 920 and sends them to the second radio unit 400B separately in the form of wireless packets. Each time the second radio unit 400B receives wireless packets from the first radio unit 200B, the second radio unit 400B reconstructs the wireless packets into the CEC frame data 900 in the order of the reception and sends it to the second BDP 510.

Accordingly, the HDMI system 100B can reduce the transfer-start required time as compared with a comparative example in which the invention is not applied, so that all of the CEC frame data 900 can be received by the second BDP 510 (destination) at an early timing irrespective of the data amount of the CEC frame data 900. Accordingly, since all the CEC frame data 900 can be received by the PDP 300 at an earlier timing than that in the comparative example, the time required for stopping the one-second timer can be reduced and generation of timeout can be restrained. In addition, transmission/receipt response for all CEC communication can be enhanced. Thus, the transmission process from the first devices 300, 310 and 320 to the second devices 500, 510, 520 and 530 can be appropriately performed.

Further, even in a transmission process from the second devices 500, 510, 520 and 530 to the first devices 300, 310 and 320, since the first radio unit 200B and the second radio unit 400B perform similar operations, an appropriate operation can also be ensured.

Further, generally in CEC communication between the networks having different CEC lines (i.e. the first and second networks 101 and 102), the invention allows an operation only by an addition of a predetermined processing time, new command transmission that is not essential to the first and the second networks 101 and 102 can be restrained, related commands can be synchronized and deterioration of transmission/receipt response can be minimized. Further, imbalance of communication traffic caused on account of separation of the CEC signal line 103 can be simultaneously restrained.

In a further exemplary embodiment, when receiving the Give command from the PDP 300, the first radio unit 200C of the HDMI system 100C gives an ACK response. Then, the first radio unit 200C sends a Give command to the second BDP 510 and sends a dummy command to all of the first devices 300, 310 and 320.

Accordingly, by performing a process in response to the dummy command by all of the first devices 300, 310 and 320 after sending the Give command, the first radio unit 200C can restrict the transmission of, for instance, a new Give command by the first devices 300, 310 and 320 before the Report command is sent back. Accordingly, non-essential command transmission caused on account of the transmission of new Give command to the second radio unit 400C as shown in steps S94 to S97 before the Report command is sent back can be restrained, thereby allowing synchronization of a sequence of related command actions. Further, imbalance of communication traffic caused on account of separation of the CEC signal line 103 between the first and the second CEC networks can also be restrained.

In still further exemplary embodiment, the second radio unit 400C of the HDMI system 100C having received the Report command sends the Report command to the first radio unit 200C and sends a dummy command to all of the second devices 500, 510, 520 and 530.

Accordingly, by performing a process in response to the dummy command by all of the second devices 500, 510, 520 and 530 after sending the Report command, the second radio unit 400C can keep the second devices 500, 510, 520 and 530 from, for instance, sending a new Give command. Accordingly, non-essential command transmission caused on account of the transmission of new Give command to the first radio unit 200C as shown in steps S94 to S97 before it is recognized that the Report command is received by the PDP 300 can be restrained, thereby allowing synchronization of a sequence of related command actions. Further, imbalance of communication traffic caused on account of separation of the CEC signal line 103 between the first and the second CEC networks can also be restrained.

### INDUSTRIAL APPLICABILITY

The present invention is applicable as a data processing device, a data processing system, a data processing method and program for data processing, a recording medium storing the program; and a data transfer device, a method and a program for data transfer, and a recording medium storing the program.

1-21. (canceled)

22. A data processing device that receives CEC frame data containing second device information specifying a second device designated as a destination from a first device as processing data, and sends the processing data to a second device adapted to perform a process based on the processing data, the data processing device comprising:
a processing-side memory that stores the second device information specifying the second device;
a data receiver that receives the processing data from the first device;
an ACK response substitution executor that gives an ACK response for reporting reception of the processing data by the second device specified by the second device information in place of the second device when the data receiver receives the processing data; and
a data transmitter that transmits the processing data received by the data receiver to the second device specified by the second device information, wherein
the ACK response substitution executor gives the ACK response in place of the second device when the second device information contained in the processing data is stored in the processing-side memory and the processing data does not contain a command that requires a return response,
the ACK response substitution executor does not give the ACK response in place of the second device when the second device information contained in the processing data is stored in the processing-side memory and the processing data contains a command that requires a return response, and
the ACK response substitution executor gives the ACK response in place of the second device when the ACK response substitution executor recognizes that the second device receives the processing data.

23. A data processing system comprising:
a data transfer device comprising a data transferer that receives CEC frame data containing second device information specifying a second device designated as a destination from a first device as processing data and is connected to a second device adapted to perform a process based on the processing data to transfer the processing data to the second device specified by the second device information; and
the data processing device according to claim 22 being connected to the first device and the data transfer device to send the processing data from the first device to the second device via the data transfer device.

24. A data transfer device that receives CEC frame data containing second device information specifying a second device designated as a destination from a first device as processing data, and transfers the processing data to a second device adapted to perform a process based on the processing data, the data transfer device comprising:
a data transferer that transfers the processing data to the second device specified by the second device information, and when receiving a return response from the second device to the processing data, transfers the return response to the first device; and
a second command transmitter that transmits a predetermined command information to all of the second devices when recognizing that the return response is received by the data transferer, wherein
when recognizing that the transfer of the return response to the first device is completed in the data transferer, the second command transmitter stops transmitting the predetermined command information.

25. A data processing system, comprising:
a data processing device that receives CEC frame data containing second device information specifying a second device designated as a destination from a first device as processing data, and sends the processing data to a second device adapted to perform a process based on the processing data; and
the data transfer device according to claim 24 that transmits the processing data transmitted by the data processing device to the second device specified by the second device information.

26. A data processing method by a computer, comprising:
receiving CEC frame data containing second device information specifying a second device designated as a destination from a first device as processing data;
sending the processing data to a second device adapted to perform a process based on the processing data;
providing a processing-side memory that stores the second device information specifying the second device;
receiving the processing data from the first device;
judging whether or not the second device information contained in the processing data is stored in the processing-side memory and whether or not the processing data contains a command that requires a return response;
giving an ACK response reporting that the processing data is received by the second device specified by the second device information in place of the second device only when, in the judging, the second device information contained in the processing data is included in the processing-side memory and the processing data does not include the command that requires the return response; and
transmitting the processing data received in the receiving to the second device specified by the second device information.

27. A data transfer method using a data processing system comprising:
a data transfer device comprising a data transferer that receives CEC frame data containing second device information specifying a second device designated as a destination from a first device as processing data and is connected to a second device adapted to perform a process based on the processing data to transfer the processing data to the second device specified by the second device information; and a data processing device connected to the first device and the data transfer device to send the processing data from the first device to the second device via the data transfer device, the method transferring the processing data to the second device and comprising:
dividing the processing data into a first divided data and a second divided data succeeding the first divided data;
receiving the first divided data by the data processing device in a first time
transmitting the first divided data to the data transfer device in a third time shorter than the first time;
receiving the second divided data by the data processing device in a second time
transmitting the second divided data to the data transfer device in a fourth time shorter than the second time;
after receiving the first divided data by the data transfer device from the data processor, transmitting the first divided data to the second device in the first time; and
after receiving the second divided data by the data transfer device from the data processor, transmitting the second divided data to the second device in the second time subsequently to the first divided data.

28. A storage medium storing a data processing program that allows a computer to run the data processing method according to claim 26 in a computer-readable manner.

29. A storage medium storing a data transfer program that allows a computer to run the data transfer method according to claim 27 in a computer-readable manner.

30. A storage medium storing a data processing program that makes a computer to function as the data processing device according to claim 22 in a computer-readable manner.

31. A storage medium storing a data transfer program that makes a computer to function as the data transfer device according to claim 24 in a computer-readable manner.
